(19) United States
(12) Patent Application Publication
(10) Pub. No.: US 2007/0018930 A1
(43) Pub. Date: Jan. 25, 2007

(54) Liquid crystal display

(75) Inventors: Hee-Wook Do, Gyeonggi-do (KR); Yoon-Sung Um, Gyeonggi-do (KR); Hak-Sun Chang, Gyeonggi-do (KR); Seung-Hoo Yoo, Gyeonggi-do (KR); Hyun-Wuk Kim, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/490,357

(22) Filed: Jul. 19, 2006

(30) Foreign Application Priority Data
Jul. 19, 2005 (KR) 10-2005-0065254

(51) Int. Cl. G09G 3/36

(52) U.S. Cl. 345/96

(57) ABSTRACT

A liquid crystal display according to the present invention includes: a plurality of pixels arranged in a matrix, each of the pixels comprising a first subpixel and a second subpixel; a plurality of first gate lines connected to the first subpixels; a plurality of second gate lines connected to the second subpixels; and a plurality of data lines intersecting the first and the second gate lines, connected to the first and the second subpixels, and transmitting data voltages, wherein voltages of the first and the second subpixels of each of the pixels have opposite polarities and are obtained from a single image information, and the data voltages carried by the data lines are subjected to N×1 (N=1, 2, . . . ) dot inversion, N:M×1 (M=1, 2, . . . ) dot inversion, or N row inversion.

### CROSS-REFERENCE TO RELATED APPLICATION

This application claims priority to and the benefit of Korean patent application no. 10-2005-0065254 filed in the Korean intellectual property office on Jul. 19, 2005, the entire contents of which are incorporated herein by reference.

### FIELD OF THE INVENTION

The present invention relates to a liquid crystal display.

### DESCRIPTION OF RELATED ART

A liquid crystal display (LCD) is one of the most widely used flat panel display devices. The LCD includes a pair of panels including field-generating electrodes such as pixel electrodes and a common electrode and a liquid crystal (LC) layer interposed between the panels. The LCD generates electric field in the LC layer by applying data voltages to the pixel electrodes and applying a common voltage to the common electrode. The desired images are obtained by controlling the strength of the electric field that determines the orientation of the LC molecules and the polarization and transmittance of incident light.

In the vertical alignment (VA) mode LCD, the long axes of the LC molecules are aligned perpendicularly to the panels in the absence of an electric field. This type of LCD is important because of its high contrast ratio and wide reference viewing angle, i.e., the viewing angle where the contrast ratio is 1:10 or the luminance sequence of grays starts to be reversed.

The wide viewing angle of the VA mode LCD can be realized by cutouts in the field-generating electrodes and protrusions on or under the field-generating electrodes that cause the tilt angles to be distributed in several directions. However, the cutouts reduce lateral visibility as compared with front visibility. To improve lateral visibility, a pixel is divided into two subpixels capacitively coupled to each other. One of the two subpixels is directly supplied with a voltage, while the other is subjected to voltage drop by the capacitive coupling such that the two subpixels have different voltages resulting in different transmittances.

However, the conventional method may not exactly control the transmittances of the two subpixels. In particular, since the transmittance varies depending on the color of light, it would be desirable to provide different voltages for the different colors are different. Moreover adding conductors to provide capacitive coupling reduces the aperture ratio and reduces transmittance due to the voltage drop caused by the capacitive coupling.

### SUMMARY OF THE INVENTION

A liquid crystal display according to an embodiment of the present invention includes: a plurality of pixels arranged in a matrix, each of the pixels comprising a first subpixel and a second subpixel; a plurality of first gate lines connected to the first subpixels and transmitting first gate signals; a plurality of second gate lines connected to the second subpixels and transmitting second gate signals; and a plurality of data lines intersecting the first and the second gate lines, wherein voltages of the first and the second subpixels of each of the pixels have opposite polarities and are obtained from a single image information, and the data voltages carried by the data lines are subjected to N×1 (N=1, 2, . . . ) dot inversion, N:M×1 (M=1, 2, . . . ) dot inversion, or N row inversion.

The first subpixel may include a first switching element connected to one of the first gate lines and one of the data lines, and a first subpixel electrode coupled to the first switching element, and the second subpixel may include a second switching element connected to one of the second gate lines and one of the data lines, and a second subpixel electrode coupled to the second switching element.

Each of the first and the second subpixel electrodes may have an inner edge and an outer edge, the inner edges of the first and the second subpixel electrodes may be bent at least once and face each other, and the outer edges of the first and the second subpixel electrodes may substantially form a rectangle.

The first subpixel electrode may have a pair of bent edges that are bent at least once, and the second subpixel electrode may have a pair of bent edges that are bent at least once.

A liquid crystal display according to another embodiment of the present invention includes: a plurality of pixels arranged in a matrix, each of the pixels comprising a first subpixel and a second subpixel; a plurality of first gate lines extending in a first direction, connected to the first subpixels, and transmitting first gate signals; a plurality of second gate lines extending in the first direction, connected to the second subpixels, and transmitting second gate signals; and a plurality of data lines intersecting the first and the second gate lines, connected to the first and the second subpixels, and transmitting data voltages, wherein voltages of the first and the second subpixels of each of the pixels have opposite polarities and are obtained from a single image information, the first subpixel comprises a first switching element connected to one of the first gate lines and one of the data lines, and a first subpixel electrode coupled to the first switching element and having a pair of bent edges facing each other, and the second subpixel comprises a second switching element connected to one of the second gate lines and one of the data lines, and a second subpixel electrode coupled to the second switching element and having a pair of bent edges facing each other.

The first subpixel electrode and the second subpixel electrode of each of the pixels may be adjacent in the first direction.

The data voltages carried by the data lines may be subjected to dot inversion, column inversion, or row inversion.

Areas of the first subpixel electrode and the second subpixel electrode may be different from each other. In particular, the first subpixel electrode may have a length in the first direction different from a length in the first direction of the second subpixel electrode. The first-directional length of the second subpixel electrode may be greater than the first-directional length of the first subpixel electrode and less than three times the first-directional length of the first subpixel electrode. The first subpixel electrode may be supplied with a data voltage greater than a data voltage supplied to the second subpixel electrode.

The liquid crystal display may further include a common electrode facing the first and the second subpixel electrodes.

The liquid crystal display may further include a tilt direction determining member disposed at the common electrode. The tilt direction determining member may include cutouts passing through the first and the second subpixel electrodes and having bent portions substantially parallel to the bent edges of the first and the subpixel electrodes.

The liquid crystal display may further include: a common electrode facing the first and the second subpixel electrodes and having first cutouts; and an insulating layer disposed on the data lines and the first and the second gate lines, wherein the first and the second subpixel electrodes may have a second cutout.

The second subpixel electrode may have an area larger than an area of the first subpixel electrode and smaller than three times the area of the first subpixel electrode. The first subpixel electrode may be supplied with a data voltage greater than a data voltage supplied to the second subpixel electrode.

A method of driving a liquid crystal display according to an embodiment of the present invention includes: applying a first data voltage to a data line of the liquid crystal display; applying a gate-on voltage to the first gate line to transmit the first data voltage to a first subpixel of a first pixel of the liquid crystal display; applying a second data voltage to the data line, the second data voltage having a polarity opposite the first data voltage; and applying the gate-on voltage to a second gate line of the liquid crystal display to transmit the second data voltage of a second subpixel of the first pixel, wherein the first data voltage and the second data voltage are generated from a single image data and have magnitudes different from each other, and the first and the second data voltages are subjected to N×1 (N=1, 2, . . . ) dot inversion, N:M×1 (M=1, 2, . . . ) dot inversion, or N row inversion.

The method may further include: applying the gate-on voltage to a third gate line of the liquid crystal display to transmit the second data voltage to a first subpixel of a second pixel; applying a third data voltage having the same polarity as the second data voltage to the data line; and applying the gate-on voltage to the third gate line to transmit the third data voltage to the first subpixel of the second pixel.

The application of the gate-on voltage to the second gate line to transmit the second data voltage may maintain longer than the application of the gate-on voltage to the first gate line to transmit the first data voltage.

### BRIEF DESCRIPTION OF THE DRAWING

The foregoing objects and features of the present invention may become more apparent from a reading of the ensuing description together with the drawing, in which:

FIGS. 1A and 1B are block diagrams of LCDs according to embodiments of the present invention;

FIG. 2 is an equivalent circuit diagram of a pixel of an LCD according to an embodiment of the present invention;

FIG. 3 is a schematic equivalent circuit diagram of a pixel of an LCD according to an embodiment of the present invention;

FIG. 4 is a layout diagram showing an arrangement of pixel electrodes and a common electrode and polarities of the voltages of the pixel electrodes in an LCD according to an embodiment of the present invention;

FIG. 5 is a layout diagram showing an arrangement of pixel electrodes and a common electrode and polarities of the voltages of the pixel electrodes in an LCD according to another embodiment of the present invention;

FIGS. 6 and 7 show waveforms of data voltages and gate signals for LCD according to embodiments of the present invention;

FIG. 8 shows pixel electrodes and cutouts in a common electrode and polarity of data voltages in an LCD according to another embodiment of the present invention;

FIGS. 9A and 9B are layout views of pixel electrodes and cutouts of a common electrode according to other embodiments of the present invention;

FIG. 10 is a layout view of an LC panel assembly according to an embodiment of the present invention;

FIG. 11 is a sectional view of the LC panel assembly shown in FIG. 10 taken along line XI-XI;

FIG. 12 is a layout view of an LC panel assembly according to another embodiment of the present invention;

FIG. 13 is a sectional view of the LC panel assembly shown-in FIG. 12 taken along line XIII-XIII;

FIG. 14 is a layout view of a lower panel for an LC panel assembly according to an embodiment of the present invention;

FIG. 15 is a layout view of an upper panel for an LC panel assembly according to an embodiment of the present invention;

FIG. 16 is a layout view of an LC panel assembly including the lower panel shown in FIG. 14 and the upper panel shown in FIG. 15; and

FIGS. 17A and 17B are sectional views of the LC panel assembly shown in FIG. 16 taken along lines XVIIA-XVIIA and XVIIB-XVIIB′-XVIIB″, respectively.

### DETAILED DESCRIPTION

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

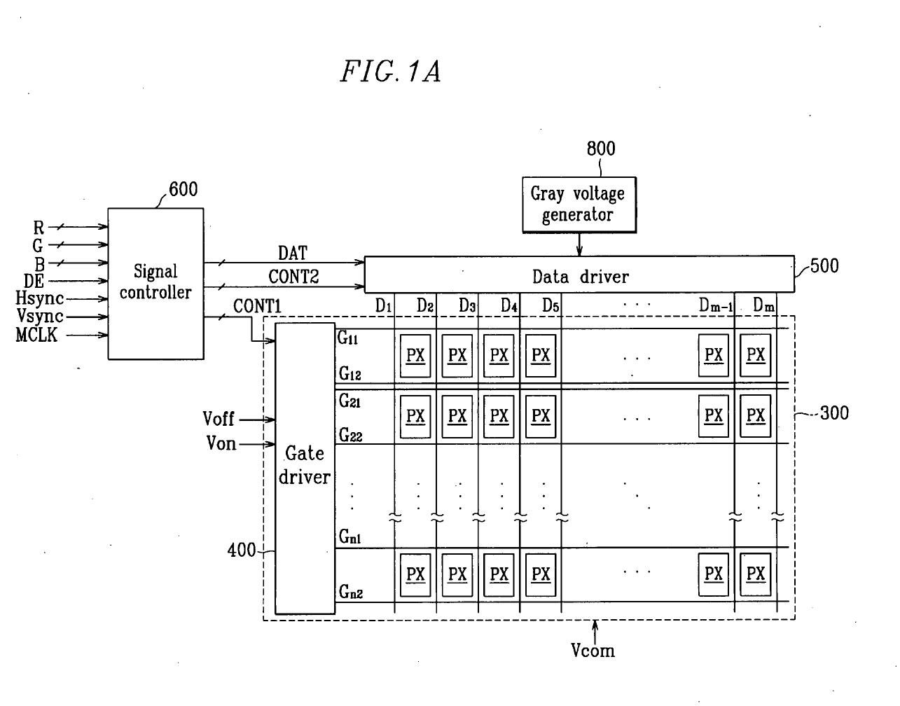

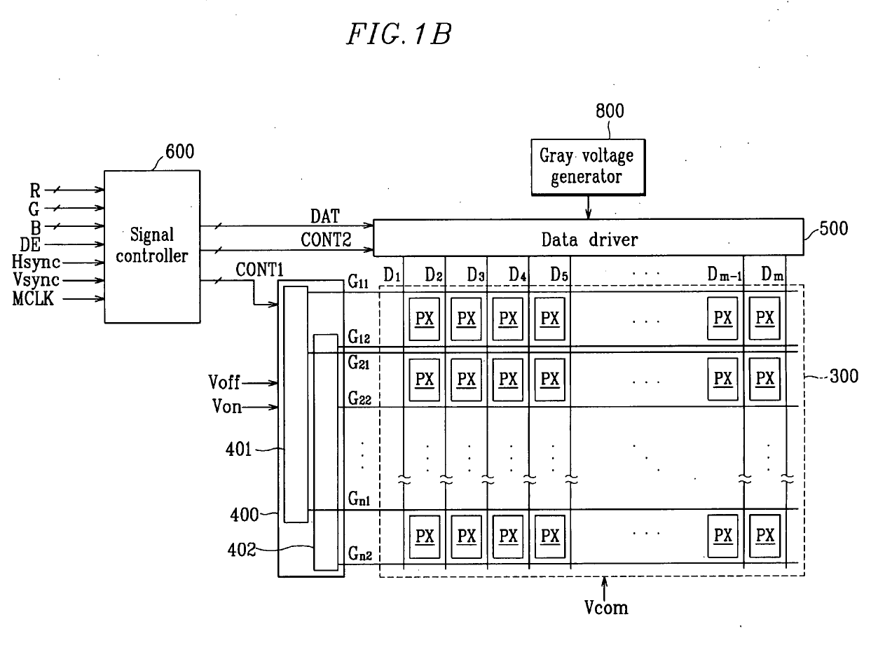

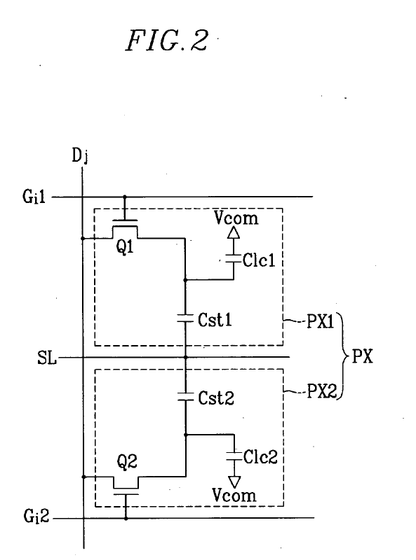

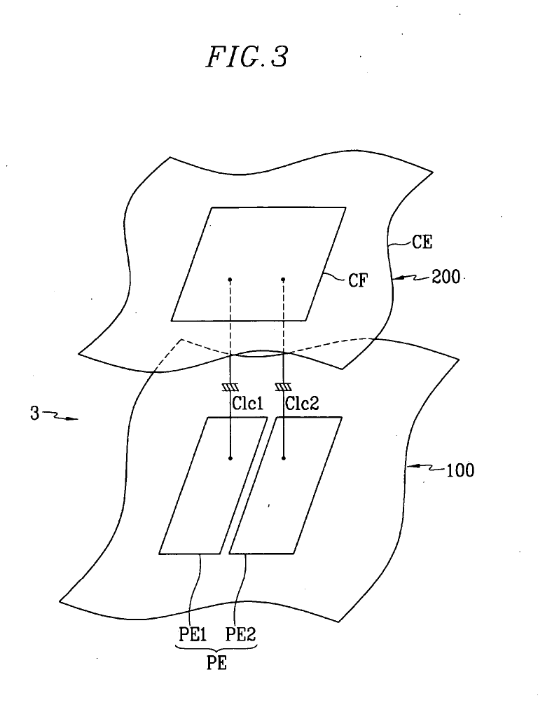

FIGS. 1A and 1B are block diagrams of LCDs according to embodiments of the present invention, FIG. 2 is an equivalent circuit diagram of a pixel of an LCD according to an embodiment of the present invention, and FIG. 3 is a schematic equivalent circuit diagram of a pixel of an LCD according to an embodiment of the present invention.

Referring to FIGS. 1A and 1B, each LCD according to embodiments includes an LC panel assembly 300, a gate driver 400 and a data driver 500 that are coupled to the panel assembly 300, a gray voltage generator 800 coupled to data driver 500, and a signal controller 600 controlling the above elements.

Referring to FIGS. 1A and 1B, the panel assembly 300 includes a plurality of gate signal lines G₁₁-Gₙ₂ and data signal lines D₁-Dₘ and a plurality of pixels PX connected thereto and arranged substantially in a matrix. In a structural view shown in FIG. 3, the panel assembly 300 includes a lower panel 100, an upper panel 200 facing the lower panel 100, and an LC layer 3 interposed therebetween.

The signal lines, which are provided on the lower panel 100 shown in FIG. 3, include a plurality of pairs of gate lines G₁₁-Gₙ₂ transmitting gate signals (also referred to as “scanning signals”), and a plurality of data lines D₁-Dₘ transmitting data signals. The gate lines G₁₁-Gₙ₂ extend substantially in a row direction and substantially parallel to each other, while the data lines D₁-Dₘ extend substantially in a column direction and substantially parallel to each other.

The signal lines may further include a plurality of storage electrode lines (not shown) extending substantially parallel to the gate lines G₁₁-Gₙ₂ and supplied with a predetermined voltage such as a common voltage Vcom.

FIG. 2 shows exemplary signal lines, which include a pair of an i-th (i=1, 2, . . . , n) upper gate line Gᵢ₁ and an i-th lower gate line Gᵢ₂, a j-th (j=1, 2, . . . , m) data line Dⱼ, and a storage electrode lines SL. The storage electrode line SL is disposed between the upper gate line Gᵢ₁ and the lower gate line Gᵢ₂.

Referring to FIG. 2, each pixel PX includes a pair of subpixels PX1 and PX2 and each subpixel PX1/PX2 includes a switching element Q1/Q2, a liquid crystal (LC) capacitor C1c1/C1c2, and a storage capacitor Cst1/Cst2. The storage capacitor Cst1 or Cst2 may be omitted if not necessary.

The switching element Q1/Q2 such as a thin film transistor (TFT) is provided on the lower panel 100 shown in FIG. 3. The switching element Q1/Q2 has three terminals: a control terminal connected to the upper/lower gate line Gᵢ₁/Gᵢ₂; an input terminal connected to the data line Dⱼ; and an output terminal coupled to the LC capacitor C1c1/C1c2 and the storage capacitor Cst1/Sct2. It is noted that the switching elements Q1 and Q2 of the two subpixels PX1 and PX2 are connected to different gate lines Gᵢ₁ and Gᵢ₂.

Referring to FIG. 3, the LC capacitor C1c1/C1c2 includes a subpixel electrode PE1/PE2 provided on the lower panel 100 and a common electrode CE provided on the upper panel 200 as two terminals. The LC layer 3 disposed between the electrodes PE1/PE2 and CE functions as dielectric of the LC capacitor C1c1/C1c2. A pair of subpixel electrodes PE1 and PE2 are separated from each other and form a pixel electrode PE. The common electrode CE is supplied with the common voltage Vcom and covers an entire surface of the upper panel 200. The LC layer 3 has negative dielectric anisotropy, and LC molecules in the LC layer 3 may be oriented so that long axes of the LC molecules are perpendicular to the surfaces of the panels 100 and 200 in absence of electric field.

Referring to FIG. 2 again, the storage capacitor Cst1/Cst2 is an auxiliary capacitor for the LC capacitor C1c1/C1c2. The storage capacitor Cst1/Cst2 is formed by the overlap of the subpixel electrode PE1/PE2 and the storage electrode line SL via an insulator (not shown). Alternatively, the storage capacitor Cst1/Cst2 may be formed by the overlap of the subpixel electrode PE1/PE2 and an adjacent gate line called a previous gate line, which overlaps the subpixel electrode PE1/PE2 via an insulator (not shown).

For color display, each pixel PX uniquely represents one of primary colors (i.e., spatial division) or each pixel PX sequentially represents the primary colors in turn (i.e., temporal division) such that spatial or temporal sum of the primary colors are recognized as a desired color. An example of a set of the primary colors includes red, green, and blue colors. FIG. 3 shows an example of spatial division in that each pixel PX includes a color filter CF representing one of the primary colors in an area of the upper panel 200 facing the pixel electrode PE. Alternatively, the color filter CF may be provided on or under the pixel electrode PE on the lower panel 100.

A pair of polarizers (not shown) are attached to outer surfaces of the panels 100 and 200. The polarization axes of the two polarizers may be crossed such that the crossed polarizers block the light incident onto the LC layer 3. One of the polarizers may be omitted.

Referring to FIG. 1 again, gate driver 400 is connected to the gate lines G₁₁-Gₙ₂ of the panel assembly 300 and synthesizes a gate-on voltage Von and a gate-off voltage Voff from an external device to generate gate signals for application to the gate lines G₁₁-Gₙ₂. Each of the gate drivers 400 shown in FIGS. 1A and 1B is disposed near an edge of the panel assembly 300. Gate driver 400 shown in FIG. 1B includes a pair of driving circuits 401 and 402 connected to upper and lower gate lines G₁₁-Gₙ₁ and G₁₂-Gₙ₂, respectively.

Gray voltage generator 800 generates a pair of groups of gray voltages related to the transmittance of the pixels PX. The pair of groups of gray voltages are separately provided for respective subpixels PX1 and PX2, and each group of gray voltages include positive-polarity gray voltages having positive polarity relative to the common voltage Vcom and negative-polarity gray voltages having negative polarity to the common voltage Vcom. However, the gray voltage generator 800 may generate only one group of gray voltages to be provided for both subpixels PX1 and PX2. In addition, the gray voltage generator 800 may generate only a given number of gray voltages (referred to as reference gray voltages) instead of generating all of the gray voltages.

Data driver 500 is connected to the data lines D₁-Dₘ of the panel assembly 300 and applies data voltages, which are selected from the gray voltages supplied from the gray voltage generator 800, to the data lines D₁-Dₘ. However, when the gray voltage generator 800 generates the reference gray voltages, data driver 500 may generate gray voltages for all the grays by dividing the reference gray voltages and select the data voltages from the generated gray voltages.

The signal controller controls gate driver 400 and the data driver, etc.

Each of the driving and processing units 400, 500, 600 and 800 may include at least one integrated circuit (IC) chip mounted on the LC panel assembly 300 or on a flexible printed circuit (FPC) film in a tape carrier package (TCP) type, which are attached to the panel assembly 300. Alternately, at least one of the driving and processing units 400, 500, 600 and 800, for example, gate driver 400 shown in FIG. 1, may be integrated into the panel assembly 300 along with the signal lines G₁₁-Gₙ₂, D₁-Dₘ and SL and the switching elements Q1 and Q2. Alternatively, all the driving and processing units 400, 500, 600 and 800 may be integrated into a single IC chip, but at least one of the driving and processing units 400, 500, 600 and 800 or at least one circuit element in at least one of the driving and processing units 400, 500, 600 and 800 may be disposed out of the single IC chip.

Now, the operation of the above-described LCD will be described in detail.

Signal controller 600 is supplied with input image signals R, G and B and input control signals controlling the display thereof from an external graphics controller (not shown). The input image signals R, G and B contains luminance information of each pixel PX, and the luminance has a predetermined number of, for example 1024(=2¹⁰), 256(=2⁸) or 64(=2⁶) grays. The input control signals include a vertical synchronization signal Vsync, a horizontal synchronization signal Hsync, a main clock MCLK, and a data enable signal DE, etc.

Signal controller 600 transmits gate control signals CONT1 to gate driver 400, and transmits digital image signals DAT having a predetermined number of values (or grays) and data control signals CONT2 to data driver 500.

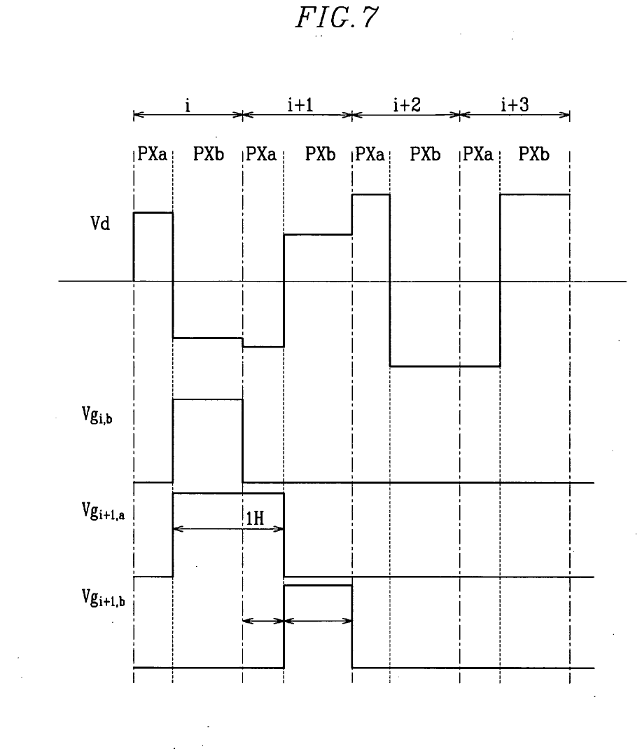

In the LCD shown in FIG. 7, signal controller 600 receives input image signals R, G and B and converts an input image signal R, G and B for each pixel PX into a pair of output image signals DAT for two subpixels PXa and PXb to be supplied to data driver 500. Otherwise, gray voltage generator 800 generates a pair of groups of gray voltages for respective subpixels PXa and PXb. The two groups of gray voltages are alternately supplied by gray voltage generator 800 to data driver 500 or alternately selected by data driver 500 such that the two subpixels PXa and PXb are supplied with different voltages.

At this time, the values of the digital output image signals and the values of the gray voltages in each group are preferably determined such that the synthesis of gamma curves for the two subpixels PXa and PXb approaches a reference gamma curve at a front view. For example, the synthesized gamma curve at a front view coincides with the most suitable reference gamma curve at a front view, and the synthesized gamma curve at a lateral view is the most similar to the reference gamma curve at a front view.

The gate control signals CONT1 include a scanning start signal STV for instructing to start scanning and at least a clock signal for controlling the output time of the gate-on voltage Von. The gate control signals CONT1 may further include an output enable signal OE for defining the duration of the gate-on voltage Von.

Data control signals CONT2 include a horizontal synchronization start signal STH for indicating the start of data transmission for a group of subpixels PX1 or PX2, a load signal LOAD for instructing to apply the data voltages to the panel assembly 300, and a data clock signal HCLK. The data control signal CONT2 may further include an inversion signal RVS for reversing the polarity of the data voltages (relative to the common voltage Vcom).

Responsive to the data control signals CONT2 from the signal controller 600, data driver 500 receives a packet of the image signals DAT for the group of subpixels PX1 or PX2 from signal controller 600. Data driver 500 converts the image signals DAT into analog data voltages selected from the gray voltages supplied from the gray voltage generator 800, and applies the analog data voltages to data lines D₁-Dₘ.

Gate driver 400 applies the gate-on voltage Von to gate lines G₁₁-Gₙ₂ in response to the gate control signals CONT1, thereby turning on respective ones of switching elements Q1 or Q2 which supply the voltages on data lines D₁-Dₘ to subpixels PX1 or PX2 through the activated switching elements Q1 or Q2.

The two subpixels PX1 and PX2 forming each pixel PX are supplied with their respective data voltages through the same data line at different times. For this purpose, the gray voltage generator 800 generates a pair of groups of gray voltages for respective subpixels PX1 and PX2. The two groups of gray voltages are alternately supplied by the gray voltage generator 800 to data driver 500 or alternately selected by data driver 500. Alternatively, signal controller 600 may convert each of the input image signal R, G and B for each pixel PX into a pair of output image signals DAT for the respective subpixels PX1 and PX2 thereof and may supply the output image signals DAT to data driver 500.

When a voltage difference is generated between two terminals of the LC capacitor Clc1/Clc2, a primary electric field substantially perpendicular to the surfaces of the panels 100 and 200 is generated in the LC layer 3 and both the pixel electrodes PE and the common electrode CE are commonly referred to as field generating electrodes. The LC molecules in the LC layer 3 tend to change their orientations in response to the electric field so that their long axes may be perpendicular to the field direction. The molecular orientations determine the polarization of light passing through the LC layer 3. The polarizer(s) converts the light polarization into the light transmittance such that the pixels PX display the luminance represented by the image signal DAT.

The tilt angle of the LC molecules depends on the strength of the electric field. When the voltages of the LC capacitors Clc1 and Clc2 are different from each other, the tilt angles of the LC molecules in the subpixels are different from each other and thus the luminance of the two subpixels are different. Accordingly, the voltages of the two subpixels can be adjusted so that an image viewed from a lateral side is closer to an image viewed from the front, that is, the lateral gamma curve is closer to the front gamma curve, thereby improving lateral visibility.

By repeating this procedure by a unit of a horizontal period (which is denoted by “1H” and equal to one period of the horizontal synchronization signal Hsync or the data enable signal DE), all the pixels PX are supplied with data voltages.

When the next frame starts after one frame finishes, the inversion control signal RVS applied to data driver 500 is controlled such that the polarity of the data voltages is reversed (which is referred to as “frame inversion”).

The inversion control signal RVS may be also controlled such that the polarity of the data voltages flowing in a data line D₁-Dₘ are periodically reversed during one frame (for example, row inversion and dot inversion), or the polarity of the data voltages in one packet are reversed (for example, column inversion and dot inversion). In the dot inversion, etc., the data voltages flowing in adjacent data lines have opposite polarities, and the polarity of the data voltages in each data line D₁-Dₘ swings between positive and negative.

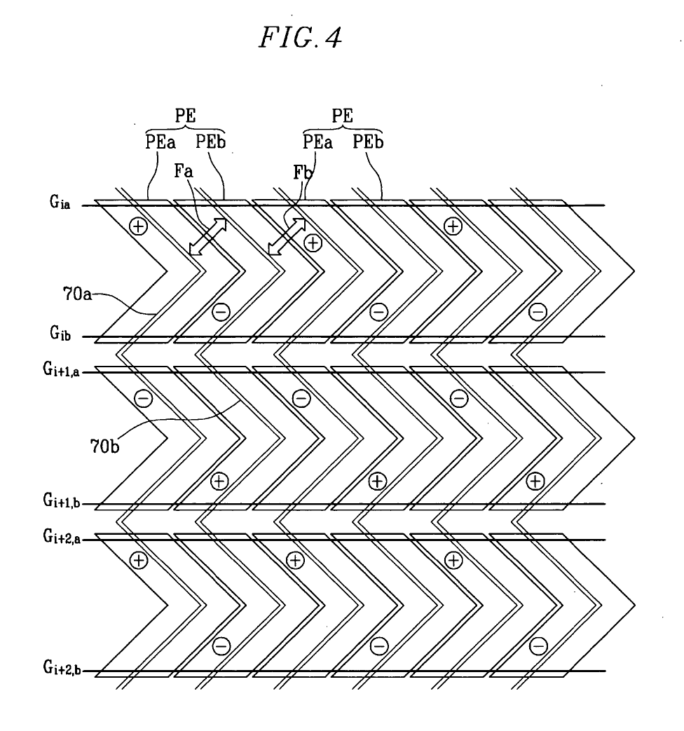

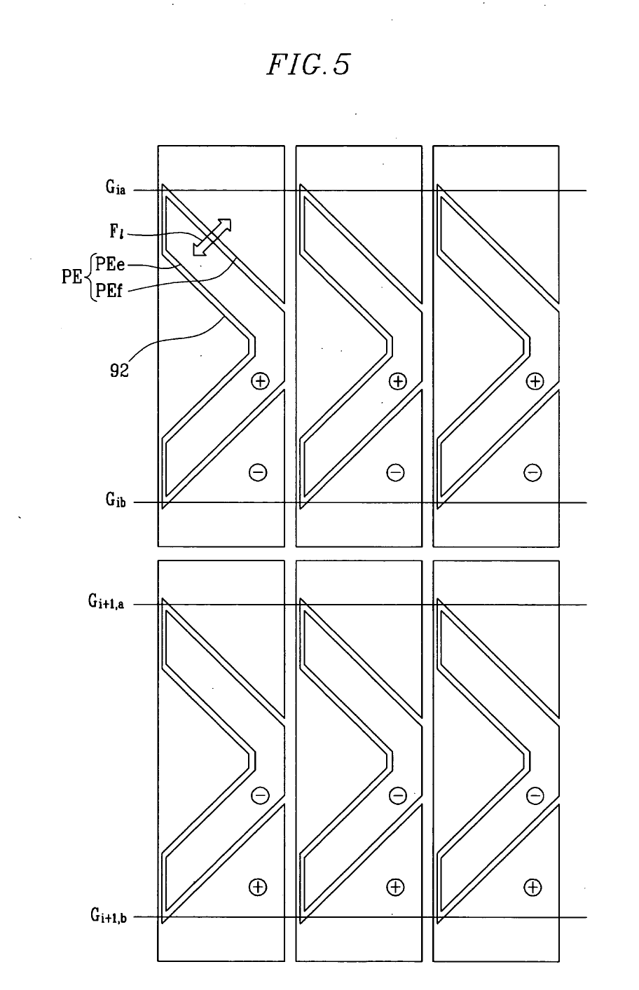

Detailed structures of pixel electrodes and common electrodes in LCDs according to embodiments of the present invention will be described in detail with reference to FIGS. 4 and 5.

FIG. 4 is a layout diagram showing an arrangement of pixel electrodes and a common electrode and polarities of the voltages of the pixel electrodes in an LCD according to an embodiment of the present invention, and FIG. 5 is a layout diagram showing an arrangement of pixel electrodes and a common electrode and polarities of the voltages of the pixel electrodes in an LCD according to another embodiment of the present invention.

Referring to FIGS. 4 and 5, each pixel electrode PE of LCDs includes a first subpixel electrode PEa or PEe and a second subpixel electrode PEb or PEf that are separated from each other. A pair of gate lines G₁ₐ and G_{1b}, G_{i+1,a} and G_{i+1,b}, or G_{i+2,a} and G_{i+2,b,} extending substantially in a transverse direction are disposed near transverse edges of each pixel electrode PE.

Referring to FIG. 4, the subpixel electrodes PEa and PEb of each pixel electrode PE are adjacent in the transverse direction, and a common electrode CE (shown in FIG. 2) has a plurality of cutouts 70a and 70b facing the subpixel electrodes PEa and PEb, respectively.

Each of the subpixel electrodes PEa and PEb has a pair of bent edges and a pair of transverse edges and has a shape of a chevron. The bent edges includes a convex edge meeting the transverse edges at an obtuse angle, for example, about 135 degrees, and a concave edge meeting the transverse edges at an acute angle, for example, about 45 degrees. Each of the bent edges, which is formed by the 90-degree meeting of a pair of oblique edges, has a bent angle of about a right angle. The transverse edges and one (referred to as an outer edge) of the bent edges of each subpixel electrode PEa or PEb of a pixel electrode PE form an outer boundary of the pixel electrode PE, while the other (referred to as an inner edge) of the bent edges thereof is disposed adjacent to the other subpixel electrode PEb or PEa.

Each of the cutouts 70a and 70b in the common electrode CE includes a plurality of bent portions connected to each other and extending in a column direction. Each of the bent portions includes a pair of oblique portions meeting at about a right angle, extends substantially parallel to the bent edges of the subpixel electrodes PEa or PEb, and bisects a subpixel electrode PEa or PEb into left and right halves.

Each of the subpixel electrodes PEa and PEb and a bent portion of each of the cutouts 70a and 70b has an inversion symmetry with respect to an imaginary straight line (referred to as a center transverse line) connecting the convex vertex and the concave vertex of the subpixel electrode PEa or PEb.

Referring to FIG. 5, each of pixel electrodes PE is substantially rectangular, and the first and the second subpixel electrodes PEe and PEf constituting a pixel electrode PE are engaged with each other with a gap 92 interposed therebetween. The edges of the subpixel electrodes PEe and PEf forming the gap 92 are referred to as inner edges, while the edges of the subpixel electrodes PEe and PEf forming the rectangle of the pixel electrode PE are referred to as outer edges. The first sub-pixel electrode PEe has a shape of a character V rotated by about a right angle and is almost enclosed by the second subpixel electrode PEf. The second sub-pixel electrode 190b includes an upper trapezoidal portion, a lower trapezoidal portion, and a middle trapezoidal portion, which are connected to each other near a left edge thereof. The middle trapezoidal portion is contained in a depression of the first subpixel electrode PEe. The gap 92 between the first sub-pixel electrode PEe and the second sub-pixel electrode PEb includes two pairs of upper and lower oblique portions three longitudinal portions. The area of the second subpixel electrode PEf is larger than the first subpixel electrode PEe and smaller than about three times the first subpixel electrode PEe. The voltage supplied to the first subpixel electrode PEe (with respect to the common electrode CE) is higher than the voltage supplied to the second subpixel electrode PEf (with respect to the common electrode CE). This configuration may make the lateral gamma curve closer to the front gamma curve.

In the meantime, the tilt direction of the LC molecules is preliminarily determined by the horizontal field component Fa (shown in FIG. 4) or F1 (shown in FIG. 5). The horizontal field component Fa or F1 is generated by cutouts 70a and 70b of common electrode CE, gaps 92, and the edges of the subpixel electrodes PEa and PEb, which distort the primary electric field. The horizontal field component Fa or F1 is substantially perpendicular to the edges of the cutouts 70a and 70b, the oblique edges of the gaps 92, and the edges of the subpixel electrodes PEa and PEb.

Referring to FIGS. 4 and 5, since the LC molecules on each of sub-areas divided by the cutouts 70a and 70b or the gaps 92 tilt perpendicular to the oblique edge(s) of the sub-area, the azimuthal distribution of the tilt directions are localized to four directions, thereby increasing the reference viewing angle of the LCD.

Referring to FIG. 4, the direction of a secondary electric field Fb due to the voltage difference between adjacent pixel electrodes PE is perpendicular to the oblique edges of the sub-areas. Accordingly, the field direction of the secondary electric field Fb coincides with that of the horizontal component Fa of the primary electric field. Consequently, the secondary electric field Fb between the adjacent pixel electrodes PE enhances the determination of the tilt directions of the LC molecules.

Meanwhile, a pattern of the polarity of the voltages outputted from data driver 500 may be different from a pattern of the polarity of the voltages of the subpixels in the panel assembly 300. Hereinafter, an inversion driven by data driver 500 through the data lines 171 is referred to as a driver inversion, while an inversion that appears over the subpixels in the panel assembly 300 is referred to as an apparent inversion.

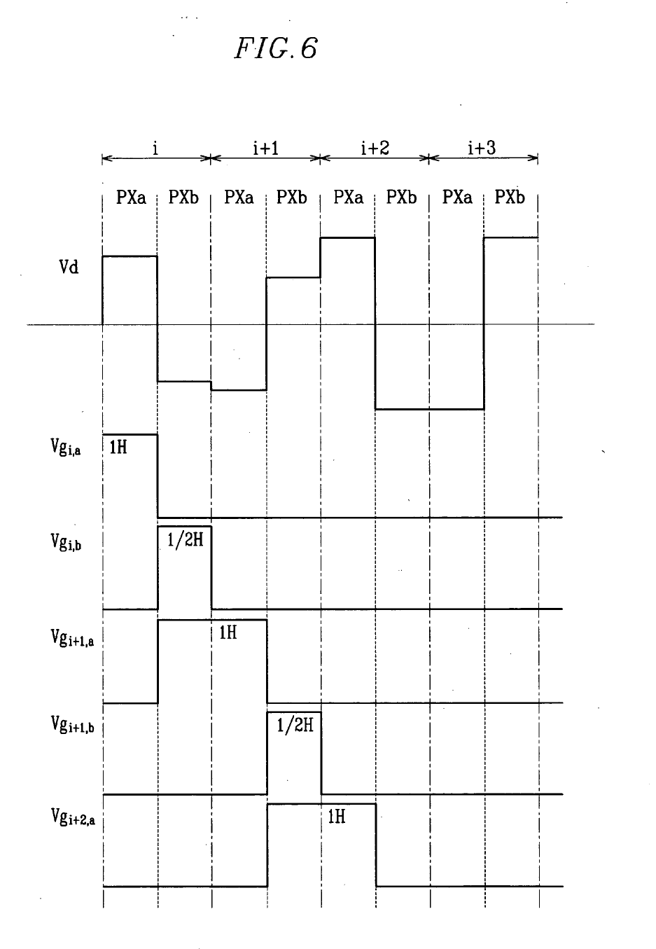

Now, the inversions of the LCD according to embodiments of the present invention will be described in detail with reference to FIGS. 6 and 7 as well as FIGS. 4 and 5.

FIGS. 6 and 7 show waveforms of data voltages and gate signals for LCD according to embodiments of the present invention.

Referring to FIGS. 4 and 5, the apparent inversion type is 1×1 dot inversion where the subpixel electrodes PEa and PEb; or PEe and PEf of each of the pixel electrodes PE have opposite polarities, and the subpixel electrodes PEa, PEb, PEe and PEf adjacent in the row direction or in the column direction have opposite polarities. The driver inversion type may be a row inversion, a 1×1 dot inversion, a 2×1 dot inversion, or a column inversion, depending on the connection between the subpixel electrodes PEa, PEb, PEe, and PEf and the data lines.

This configuration causes a strong lateral field between the subpixel electrodes PEa and PEb or PEe and PEb of each of the pixel electrodes PE as well as between the subpixel electrodes PEa, PEb, PEe and PEb of different pixel electrodes PE, which enhances the determination of the tilt directions of the liquid crystal molecules and increases the response time. Therefore, a display device larger than about 40″ display device can achieve high transmittance and can have sub-areas having a width greater than about 30 microns.

In particular, the pixel electrodes PE shown in FIG. 5 can have the gaps 92 having decreased width such that the aperture ratio is increased.

In addition, this configuration may reduce the flickering that may occur when an LCD displays an image pattern periodically arranged by a unit of a given number of pixels, as compared with a configuration where the polarity is reversed every pixel but not every subpixel.

Referring to FIGS. 6 and 7; the polarity of the data voltages Vd is reversed in a period of 1H. The type of the driver inversion is 2×1 dot inversion or two-row inversion. That is, the polarity of the data voltages flowing in a data line is reversed every two consecutive data voltages. For example, the first subpixel electrodes PXa or PXe in the i-th row are supplied with positive-polarity data voltages, and the second subpixel electrodes PXb or PXf in the i-th row are supplied with negative-polarity data voltages.

Consecutively, the first subpixel electrodes PXa or PXe in the (i+1)th row are supplied with negative-polarity data voltages, and the second subpixel electrodes PXb or PXf in the (i+1)th row are supplied with positive-polarity data voltages. This operation is easily obtained by setting the timing of the inversion control signal RVS to (½)H.

In order to give sufficient charging time, the gate signals Vgᵢₐ, Vg_{i+1,a} and Vg_{i+2,a} for the first gate lines Gᵢₐ, G_{i+1,a} and G_{i+2,a} are maintained in the gate-on voltage Von for about 1H although the gate-on signals Vg_{ib} and Vg_{i+1,b} for the second gate lines G_{ib} and G_{i+1,b} are maintained in the gate-on voltage Von for about (1/2)H. In addition, the application of the gate-on voltage Von to the first gate lines G_{i+1,a} and G_{i+2,a} overlaps the application of the gate-on voltage Von to the second gate lines G_{ib} and G_{i+1,b} in a previous row since the first subpixels PXa or PXb have the same polarity as the second subpixels PXb or PXf in a previous row.

Referring to FIG. 7, the charging time for the second subpixel electrodes PXb and PXf is increased to be greater than about (½)H, and for this purpose, the time for applying the data voltages for the first subpixels PXa and PXe to the data lines is decreased to be less than about (½)H, while the time for applying the data voltages for the second subpixels PXb and PXf to the data lines is decreased to be less than about (½)H. In addition, the time for applying the gate-on voltage to the second gate lines G_{ib} and G_{i+1,b} is increased to be greater than about (½)H, and thus the overlap of the application of the gate-on voltage Von to the first gate lines G_{i+i,a} and G_{i+2,a} and the second gate lines G_{ib} and G_{i+1,b} is increased. Accordingly, the charging times for applying the data voltages to the first and the second subpixels PXa, PXb, PXe and PXf are both increased such that insufficient charging time due to the polarity inversion 30 between adjacent previous frames in a frame inversion and signal delay in the data lines due to the polarity inversion between adjacent data voltages can be improved.

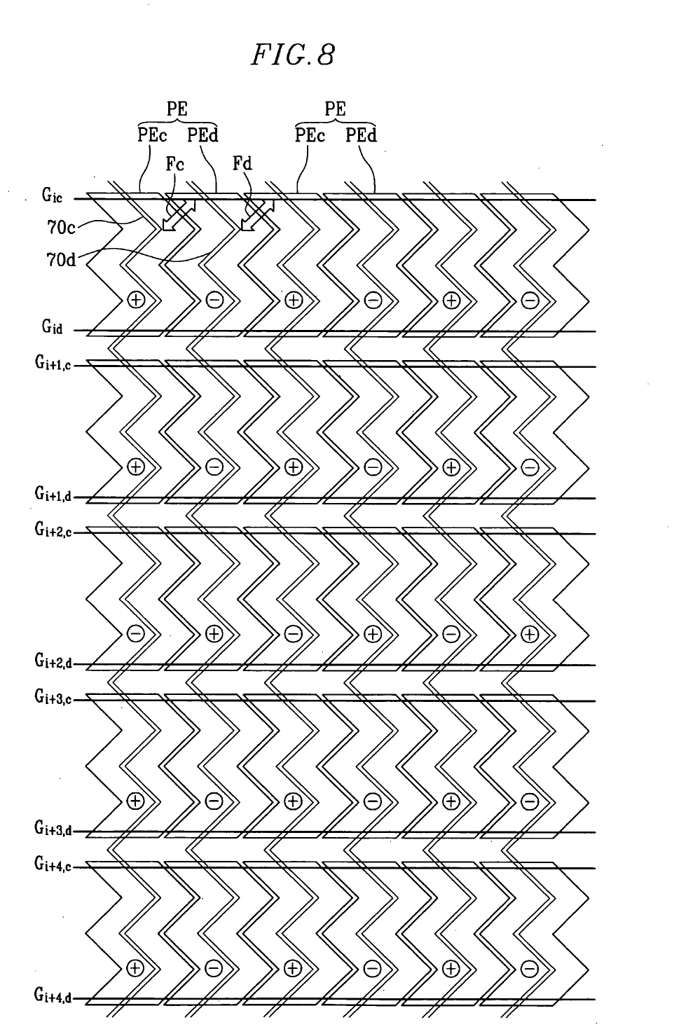

Next, a structure of pixel electrodes and a common electrode and an inversion driving according to another embodiment of the present invention will be described with reference to FIG. 8.

FIG. 8 shows pixel electrodes and cutouts in a common electrode and polarity of data voltages in an LCD according to another embodiment of the present invention.

Referring to FIG. 8, pixel electrodes PE of an LCD according to this embodiment are arranged in the row direction and the column direction, and each pixel electrode PE includes a first subpixel electrode PEc and a second subpixel electrode PEd that are separated from each other. A pair of gate lines G_{ic} and G_{id}, G_{i+1,c} and G_{i+1,d}, G_{i+2,c} and G_{i+2,d}, G_{i+3,c} and G_{i+3,d}, or G_{i+4,c} and G_{i+4,d} extending substantially in a transverse direction are disposed near transverse edges of each pixel electrode PE.

The subpixel electrodes PEc and PEd of each pixel electrode PE are adjacent in the transverse direction, and a common electrode 270 (shown in FIG. 2) has a plurality of cutouts 70c and 70d facing the subpixel electrodes PEc and PEd, respectively.

Each of the subpixel electrodes PEc and PEd has a pair of twice-bent edges and a pair of transverse edges and has a shape of a chevron. Each of the bent edges includes four oblique edges connected to each other to form a character W and the bent edges are connected to the transverse edges. The bent edges, which is formed by the 90-degree meeting of the oblique edges, has a bent angle of about a right angle.

Each of the cutouts 70c and 70d in the common electrode CE includes a plurality of bent portions connected to each other and extending in a column direction. Each of the bent portions includes a pair of oblique portions meeting at about a right angle and extending substantially parallel to the bent edges of the subpixel electrodes PEc or PEd. Two consecutive bent portions of the cutouts 70c and 70d bisect a subpixel electrode PEc or PEd into left and right halves.

First and second subpixel electrodes PEc and PEd forming each pixel electrode PE have opposite polarities. The polarity of the voltages of the first subpixel electrodes PEc or the second subpixel electrodes PEd in a subpixel column is reversed in a manner of 2-1 inversion. For example, in a subpixel column, two successive positive/negative data voltages and one negative/positive voltage are alternately arranged. Hereinafter, the above-described inversion is referred to as 2:1×1 dot inversion for subpixel electrodes. The data voltages in two consecutive pixel rows may be the same and the data voltages in the next pixel row may be opposite thereto, which is referred to as 2:1 row inversion.

Reference numerals Fc and Fd denote a horizontal component of a primary electric field and a secondary electric field between the pixel electrodes PE, respectively.

Many features of the LCD shown in FIGS. 1A-7 may be applicable to the LCD shown in FIG. 8.

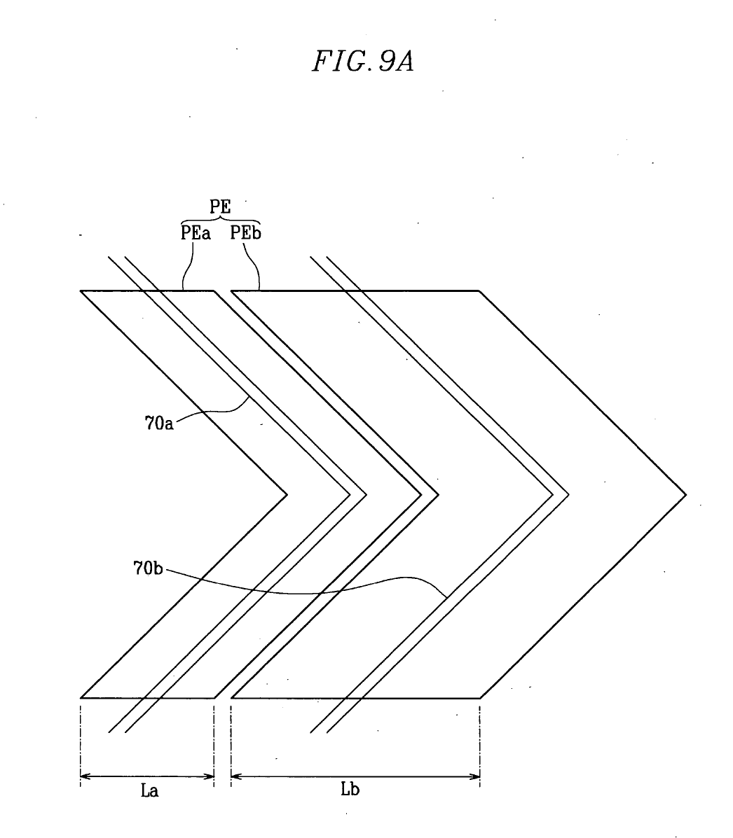

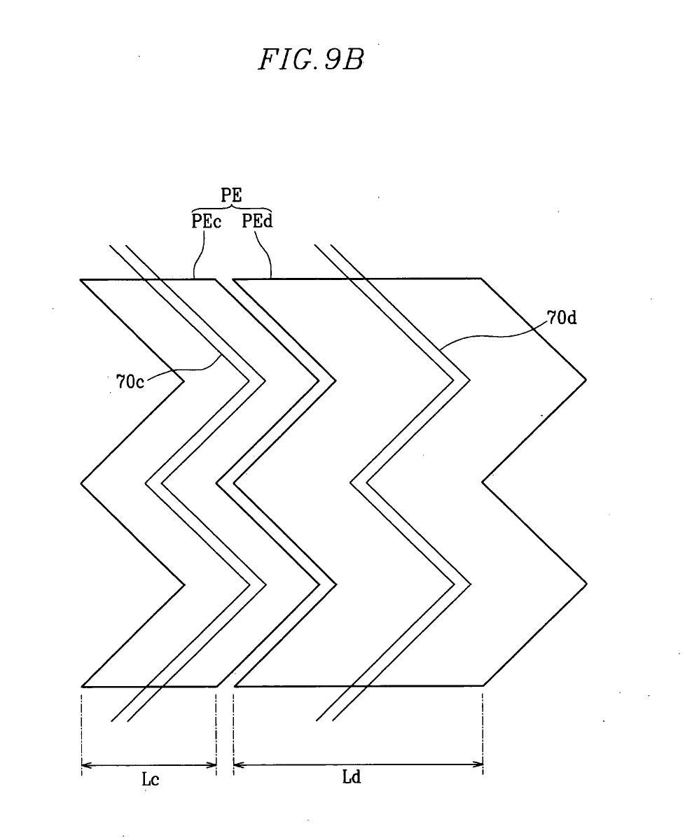

Next, structures of pixel electrodes and cutouts of a common electrode according to other embodiments of the present invention will be described with reference to FIGS. 9A and 9B.

FIGS. 9A and 9B are layout views of pixel electrodes and cutouts of a common electrode according to other embodiments of the present invention.

The structures of pixel electrodes PE and cutouts 70a-70d of a common electrode CE shown in FIGS. 9A and 9B are almost the same as those shown in FIGS. 4 and 8, respectively.

However, the length Lb or Ld of transverse edges of each of the second subpixel electrodes PEb and PEd is about 1-3 times the length La or Lc of transverse edges of each of the first subpixel electrodes PEa and PEc, and thus the area of each of the second subpixel electrodes PEb and PEd is about 1-3 times the area of transverse edges of each of the first subpixel electrodes PEa and PEc.

This configuration causes the lateral gamma curve to approach the front gamma curve as described above. In particular, when the areal ratio of the first subpixel electrode PEa or PEc and the second subpixel electrode PEb or PEd is equal to about 1:2, the lateral gamma curve further approaches the front gamma curve to improve lateral visibility.

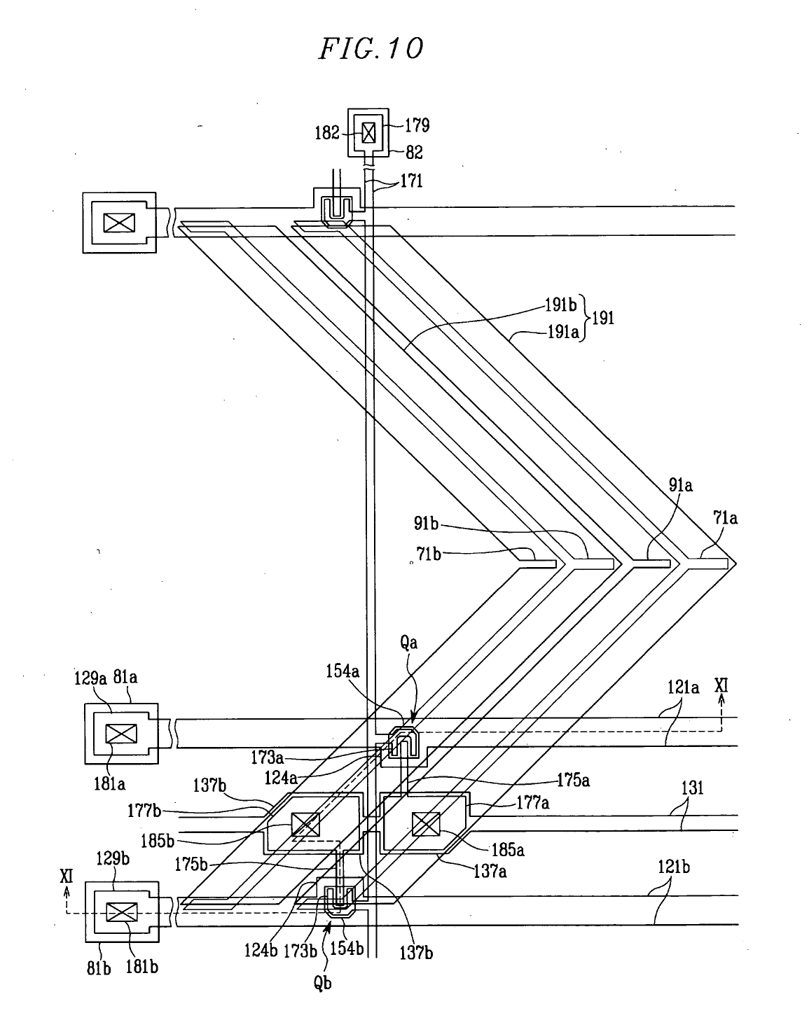

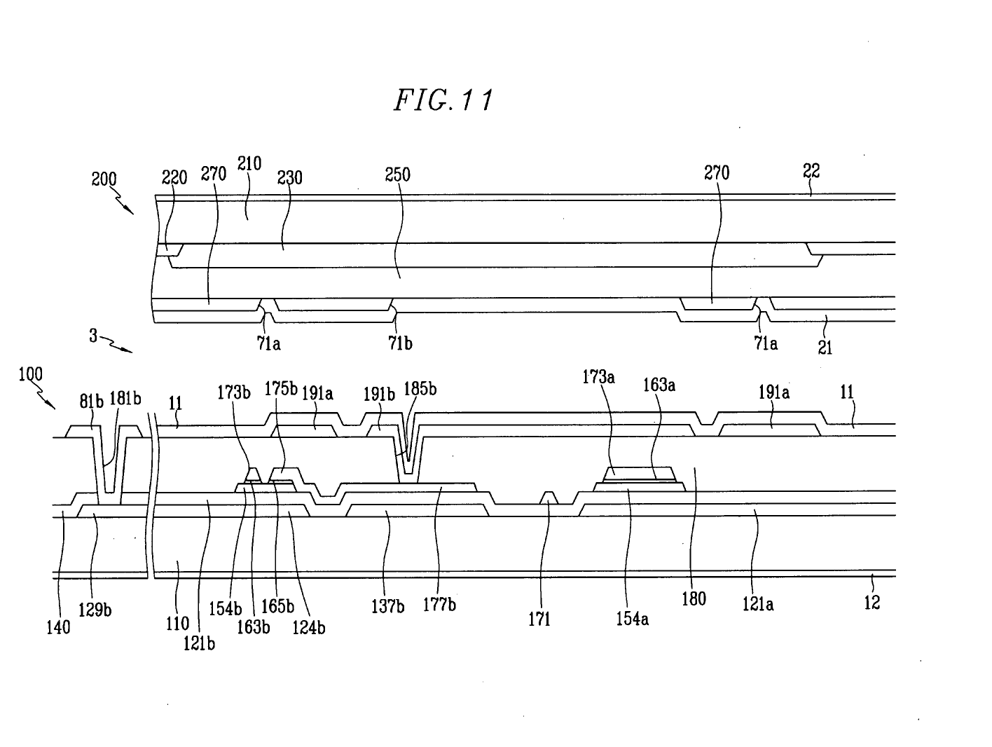

Now, an LC panel assembly according to an embodiment of the present invention will be described in detail with reference to FIGS. 10 and 11 as well as FIGS. 1A-4.

FIG. 10 is a layout view of an LC panel assembly according to an embodiment of the present invention, and FIG. 11 is a sectional view of the LC panel assembly shown in FIG. 10 taken along line XI-XI.

Referring to FIGS. 10 and 11, an LC panel assembly according to an embodiment of the present invention includes a lower panel 100, an upper panel 200 facing the lower panel 100, and a liquid crystal layer 3 interposed between the panels 100 and 200.

First, the lower panel 100 will be described.

A plurality of gate conductors including a plurality of pairs of first and second gate lines 121a and 121b and a plurality of storage electrode lines 131 are formed on an insulating substrate 110 such as transparent glass or plastic.

The gate lines 121a and 121b transmit gate signals, extend substantially in a transverse direction, and are disposed at relatively upper and lower positions, respectively.

Each of the first gate lines 121a includes a plurality of first gate electrodes 124a projecting downward and an end portion 129a having a large area for contact with another layer or an external driving circuit. Each of the second gate lines 121b includes a plurality of second gate electrodes 124b projecting upward and an end portion 129b having a large area for contact with another layer or an external driving circuit. The gate lines 121a and 121b may extend to be connected to a gate driver 400 that may be integrated on the substrate 110.

The storage electrode lines 131 are supplied with a predetermined voltage such as the common voltage Vcom and extend substantially parallel to the gate lines 121a and 121b. Each of the storage electrode lines 131 is disposed between first and second gate lines 121a and 121b and it is nearly equidistant from the first gate line 121a and the second gate line 121b. Each of the storage electrode lines 131 includes a plurality of pairs of first and second storage electrodes 137a and 137b expanding upward and downward. However, the storage electrode lines 131 may have various shapes and arrangements.

The gate conductors 121a, 121b and 131 may be made of Al containing metal such as Al and Al alloy, Ag containing metal such as Ag and Ag alloy, Cu containing metal such as Cu and Cu alloy, Mo containing metal such as Mo and Mo alloy, Cr, Ta, or Ti. However, they may have a multi-layered structure including two conductive films (not shown) having different physical characteristics. One of the two films may be made of low resistivity metal including Al containing metal, Ag containing metal, and Cu containing metal for reducing signal delay or voltage drop. The other film may be made of material such as Mo containing metal, Cr, Ta, or Ti, which has good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. However, the gate conductors 121a, 121b and 131 may be made of various metals or conductors.

The lateral sides of the gate conductors 121a, 121b and 131 are inclined relative to a surface of the substrate, and the inclination angle thereof ranges about 30-80 degrees.

A gate insulating layer 140 that may be made of silicon nitride (SiNx) or silicon oxide (SiOx) is formed on the gate conductors 121a, 121b and 131.

A plurality of first and second semiconductor islands 154a and 154b that may be made of hydrogenated amorphous silicon (abbreviated to “a-Si”) or polysilicon are formed on the gate insulating layer 140. The first/second semiconductor islands 154a/154b are disposed on the first/second gate electrodes 124a/124b.

A plurality of ohmic contact islands 163a, 163b and 165b are formed on the semiconductor islands 154a and 154b. The ohmic contact islands 163a, 163b and 165b may be made of n+ hydrogenated a-Si heavily doped with n type impurity such as phosphorous or they may be made of silicide. The ohmic contacts 163b and 165b are disposed on the second semiconductor islands 154b in pairs, and the ohmic contacts 163a and other ohmic contact islands (not shown) are disposed on the first semiconductor islands 154a in pairs.

The lateral sides of the semiconductor islands 154a and 154b and the ohmic contacts 163a, 163b and 165b are inclined relative to the surface of the substrate 110, and the inclination angles thereof may be in a range of about 30-80 degrees.

A plurality of data conductors including a plurality of data lines 171 and a plurality of pairs of first and second drain electrodes 175a and 175b are formed on the ohmic contacts 163a, 163b and 165b and the gate insulating layer 140.

The data lines 171 transmit data signals and extend substantially in the longitudinal direction to intersect the gate lines 121a and 121b and the storage electrode lines 131.

Each data line 171 includes a plurality of first and second source electrodes 173a and 173b projecting toward the first and the second gate electrodes 124a and 124b and curved like a character U, respectively, and an end portion 179 having a large area for contact with another layer or an external driving circuit. The data lines 171 may extend to be connected to a data driver 500 that may be integrated on the substrate 110.

The first and the second drain electrodes 175a and 175b are separated from each other and separated from the data lines 171. The first/second drain electrodes 175a/175b are disposed opposite the first/second source electrodes 173a/173b with respect to the first/second gate electrodes 124a/124b. Each of the first/second drain electrodes 175a/175b includes a wide end portion 177a/177b and a narrow end portion. The wide end portion 177a/177b has a shape of a rectangle having a chamfered corner and overlaps a storage electrode 137a/137b, and the narrow end portion is partly enclosed by a first/second source electrode 173a/173b.

A first/second gate electrode 124a/124b, a first/second source electrode 173a/173b, and a first/second drain electrode 175a/175b along with a first/second semiconductor island 154a/154b form a first/second TFT Qa/Qb having a channel formed in the first/second semiconductor island 154a/154b disposed between the first/second source electrode 173a/173b and the first/second drain electrode 175a/175b.

The data conductors 171, 175a and 175b may be made of refractory metal such as Cr, Mo, Ta, Ti, or alloys thereof. However, they may have a multilayered structure including a refractory metal film (not shown) and a low resistivity film (not shown). Good examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. However, the data conductors 171, 175a and 175b may be made of various metals or conductors.

The data conductors 171, 175a and 175b have inclined edge profiles, and the inclination angles thereof range about 30-80 degrees.

The ohmic contacts 163a, 163b and 165b are interposed only between the underlying semiconductor islands 154a and 154b and the overlying data conductors 171, 175a and 175b thereon and reduce the contact resistance therebetween. The semiconductor islands 154a and 154b include some exposed portions, which are not covered with the data conductors 171, 175a and 175b, such as portions located between the source electrodes 173 and the drain electrodes 175a and 175b.

A passivation layer 180 is formed on the data conductors 171, 175a and 175b and the exposed portions of the semiconductor islands 154a and 154b. The passivation layer 180 may be made of inorganic or organic insulator and it may have a flat top surface. Examples of the inorganic insulator include silicon nitride and silicon oxide. The organic insulator may have photosensitivity and dielectric constant less than about 4.0. The passivation layer 180 may include a lower film of inorganic insulator and an upper film of organic insulator such that it takes the excellent insulating characteristics of the organic insulator while preventing the exposed portions of the semiconductor islands 154a and 154b from being damaged by the organic insulator.

The passivation layer 180 has a plurality of contact holes 182 exposing the end portions 179 of the data lines 171 and a plurality of contact holes 185a and 185b exposing the first and the second drain electrodes 175a and 175b, respectively. The passivation layer 180 and the gate insulating layer 140 have a plurality of contact holes 181a and 181b exposing the end portions 129a and 129b of the gate lines 121a and 121b.

A plurality of pixel electrodes 191 and a plurality of contact assistants 81a, 81b and 82 are formed on the passivation layer 180. They may be made of transparent conductor such as ITO or IZO or reflective conductor such as Ag, Al, Cr, or alloys thereof.

Each of the pixel electrodes 191 includes a pair of subpixel electrodes 191a and 191b.

The shapes of the subpixel electrodes 191a and 191b are almost the same as those shown in FIG. 4. However, the subpixel electrode 191a/191b includes a cutout 91a/91b extending from a concave vertex of a concave edge to nearly a center of the subpixel electrode 91a/91b toward a convex vertex of a convex edge.

The first/second subpixel electrodes 191a/191b are physically and electrically connected to the first/second drain electrodes 175a/175b through the contact holes 185a/185b such that the first/second subpixel electrode 191a/191b receives data voltages from the first/second drain electrodes 175a/175b. A first/second subpixel electrode 191a/191b and the common electrode 270 form a first/second LC capacitor C1ca/C1cb, which stores applied voltages after the TFT turns off.

A first/second storage capacitor Csta/Cstb for enhancing the charge storing capacity are formed by overlapping an expansion 177a/177b of a first/second drain electrode 175a/175b connected to a first/second subpixel electrode 191a/191a with a storage electrode 137a/137b via the gate insulating layer 140.

The contact assistants 81a, 81b and 82 are connected to the end portions 129a and 129b of the gate lines 121a and 121b and the end portions 179 of the data lines 171 through the contact holes 181a, 181b and 182, respectively. The contact assistants 81a, 81b and 82 protect the end portions 129a, 129b and 179 and enhance the adhesion between the end portions 129, 129b and 179 and external devices.

The description of the upper panel 200 follows.

A light blocking member 220 referred to as a black matrix is formed on an insulating substrate 210 such as transparent glass or plastic. The light blocking member 220 may include a plurality of bent portions (not shown) facing the bent edges of the pixel electrodes 191 on the lower panel 100 and a plurality of widened portions (not shown) facing the TFTs Qa and Qb on the lower panel 100. The light blocking member 220 blocks light leakage near the pixel electrodes 191 and the TFTs Qa and Qb and may have various shapes.

A plurality of color filters 230 are also formed on the substrate 210 and the light blocking member 220. The color filters 230 are disposed substantially in the areas enclosed by the light blocking member 220 and the color filters 230 may extend substantially in the longitudinal direction along the pixel electrodes 191. Each of the color filters 230R represents one of primary colors such as red color, green color, and blue color.

An overcoat 250 is formed on the color filters 230 and the light blocking member 220. The overcoat 250 may be made of (organic) insulator and it prevents the color filters 230 from being exposed and provides a flat surface. The overcoat 250 may be omitted.

A common electrode 270 is formed on the overcoat 250. The common electrode 270 may be made of transparent conductive material such as ITO and IZO and has a plurality of sets of cutouts 71a and 71b.

Each of the cutouts 71a and 71b in the common electrode 270 includes a bent portion having a bent point, a center transverse portion connected to the bent point of the bent portion, and a pair of terminal transverse portions connected to ends of the bent portion. The bent portion of the cutout 71a or 71b includes extends substantially parallel to the bent edges of the subpixel electrode 191a or 191b and bisects the subpixel electrode 191a or 191b into left and right halves. The center transverse portion of the cutout 71a or 71b makes an obtuse angle with the bent portion, and extends toward the convex vertex of the subpixel electrode 191a or 191b. The terminal transverse portions are aligned with the transverse edges of the subpixel electrode 191a or 191b and make an obtuse angle with the bent portion.

The number of the cutouts 71a and 71b may be varied depending on the design factors, and the light blocking member 220 may also overlap the cutouts 71a and 71b to block the light leakage through the cutouts 71a and 71b.

Alignment layers 11 and 21 that may be homeotropic are coated on inner surfaces of the panels 100 and 200.

Polarizers 12 and 22 are provided on outer surfaces of the panels 100 and 200 so that their polarization axes may be crossed and the polarization axes may make about 45 degrees with the bent edges of the subpixel electrodes 191a and 191b for increasing light efficiency. One of the polarizers 12 and 22 may be omitted when the LCD is a reflective LCD.

The LCD may further include at least one retardation film (not shown) for compensating the retardation of the LC layer 3. The LCD may further include a backlight unit (not shown) supplying light to the LC layer 3 through the polarizers 12 and 22, the retardation film, and the panels 100 and 200.

It is preferable that the LC layer 3 has negative dielectric anisotropy and it is subjected to a vertical alignment.

The shapes and the arrangements of the cutouts 71a, 71b, 92a and 92b may be modified.

At least one of the cutouts 71a and 71b can be substituted with protrusions (not shown) or depressions (not shown). The protrusions may be made of organic or inorganic material and disposed on or under the field generating electrodes 191 or 270.

The operation of the LCD and the polarity inversion, which are described above, may be applicable to the LC panel assembly shown in FIGS. 10 and 11.

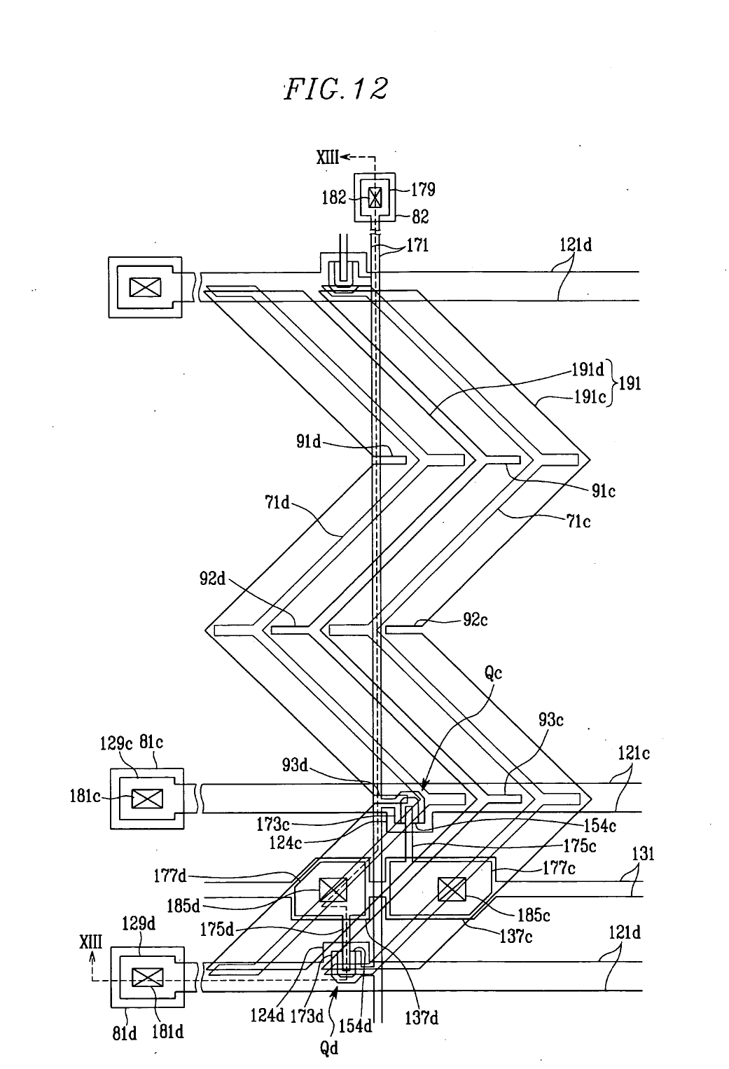

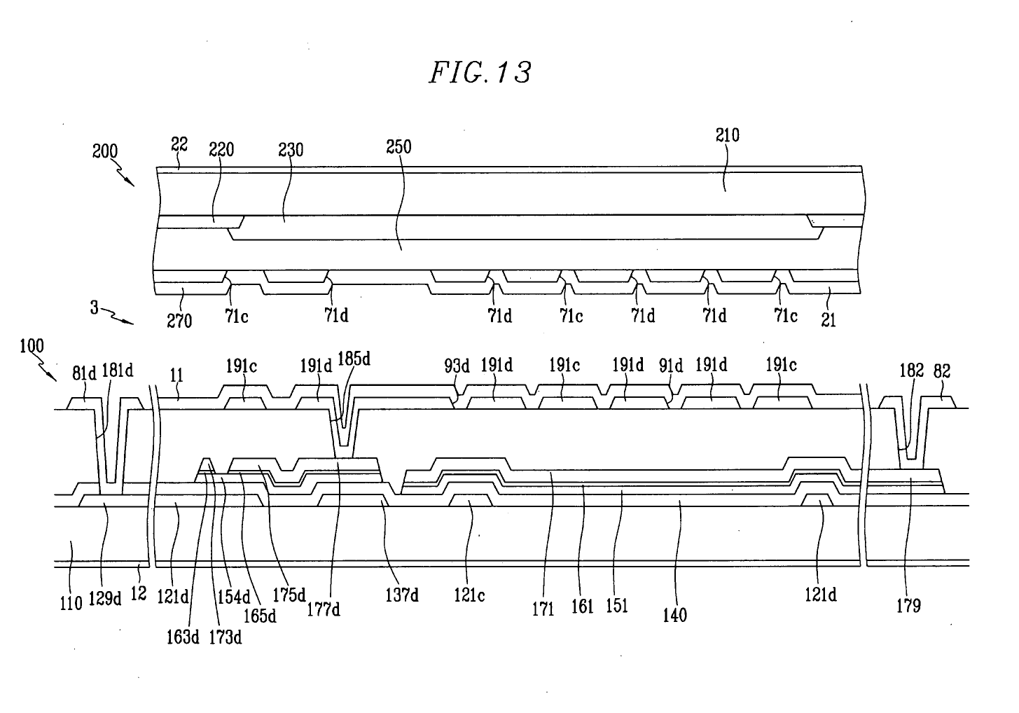

Next, an LC panel assembly according to another embodiment of the present invention will be described in detail with reference to FIGS. 12 and 13 as well as FIGS. 1A-3 and 8.

FIG. 12 is a layout view of an LC panel assembly according to another embodiment of the present invention, and FIG. 13 is a sectional view of the LC panel assembly shown in FIG. 12 taken along line XIII-XIII.

Referring to FIGS. 12 and 13, an LC panel assembly according to this embodiment includes a lower panel 100, an upper panel 200 facing the lower panel 100, an LC layer 3, and a pair of polarizers 12 and 22.

Layered structures of the LC panel assembly according to this embodiment are similar to those shown in FIGS. 10 and Regarding the lower panel 100, gate conductors including a plurality of first and second gate lines 121c and 121d and a plurality of storage electrode lines 131 are formed on a substrate 110. The first and the second gate lines 121c and 121d include first and second gate electrodes 124c and 124d and end portions 129c and 129d, respectively. The storage electrode lines 131 include a plurality of pairs of first and second storage electrodes 137c and 137d. A gate insulating layer 140 is formed on the gate conductors 121c, 121d and 131, and a plurality of semiconductor members 154c and 154d are formed on the gate insulating layer 140. A plurality of ohmic contacts 163d and 165d are formed on the semiconductor stripes 154c and 154d. Data conductors including a plurality of data lines 171 and a plurality of first and second drain electrodes 175c and 175d are formed on the ohmic contacts 163d and 165d. The data lines 171 include first and second source electrodes 173c and 173d and end portions 179, and the drain electrodes 175c and 175d include wide end portions 177c and 177d. A passivation layer 180 is formed on the data conductors 171, 175c and 175d, the gate insulating layer 140, and exposed portions of the semiconductor stripes 151. A plurality of contact holes 181c, 181d, 182, 185c and 185d are provided at the passivation layer 180 and the gate insulating layer 140. A plurality of pixel electrodes 191 including first and second subpixel electrodes 191c and 191d and having cutouts 91c-93c and 91d-93d and a plurality of contact assistants 81c, 81d and 82 are formed on the passivation layer 180, and an alignment layer 11 is formed thereon.

Regarding the upper panel 200, a light blocking member 220, a plurality of color filters 230, an overcoat 250, a common electrode 270 having a plurality of cutouts 71c and 71d, and an alignment layer 21 are formed on an insulating substrate 210.

Different from the LC panel assembly shown in FIGS. 10 and 11, the shape of the subpixel electrodes 191c and 191d is similar to that shown in FIG. 8, i.e., each of the subpixel electrodes 191c and 191d resembles a character W rotated by about a right angle. However, each of the cutouts 91c-93c of a first subpixel electrode 191c extends from a concave vertex toward a convex vertex in a transverse direction, and similarly, each of the cutouts 91d-93d of a second subpixel electrode 191d extends from a concave vertex toward a convex vertex in the transverse direction.

Each of the cutouts 71c and 71d includes a bent portion having three bent points, three intermediate transverse portions, and a pair of terminal transverse portions.

The bent portion extends substantially parallel to curved edges of the subpixel electrode 191c or 191d and bisects a subpixel electrode 191c or 191d into left and right halves. The intermediate transverse portions extend from the bent points of the bent portion approximately to the convex vertices of the subpixel electrode 191c or 191d and make obtuse angles with the bent portion. The terminal transverse portions are connected to ends of the bent portion, make obtuse angles with the bent portion, and overlap transverse edges of the subpixel electrode 191c or 191d.

In addition, the semiconductor members 154c and 154d extend along the data lines 171 and the drain electrodes 175c and 175d to form semiconductor stripes 151, and the ohmic contacts 163d extend along the data lines 171 to form ohmic contact stripes 161. The semiconductor stripes 151 have almost the same planar shapes as the data conductors 171, 175c and 175d as well as the underlying ohmic contacts 161 and 165d.

A manufacturing method of the lower panel according to an embodiment simultaneously forms the data conductors 171, 175c and 175d, the semiconductor members 151, and the ohmic contacts 161 and 165d using one photolithography process.

A photoresist pattern for the photolithography process has position-dependent thickness, and in particular, it has first and second portions with decreased thickness. The first portions are located on wire areas that will be occupied by the data conductors 171, 175c and 175d and the second portions are located on channel areas of TFTs Qc and Qd.

The position-dependent thickness of the photoresist is obtained by several techniques, for example, by providing translucent areas on the exposure mask as well as light transmitting transparent areas and light blocking opaque areas. The translucent areas may have a slit pattern, a lattice pattern, a thin film(s) with intermediate transmittance or intermediate thickness. When using a slit pattern, it is preferable that the width of the slits or the distance between the slits is smaller than the resolution of a light exposer used for the photolithography. Another example is to use reflowable photoresist. In detail, once a photoresist pattern made of a reflowable material is formed by using a normal exposure mask only with transparent areas and opaque areas, it is subject to reflow process to flow onto areas without the photoresist, thereby forming thin portions.

As a result, the manufacturing process is simplified by omitting a photolithography step.

Many of the above-described features of the LC panel assembly shown in FIGS. 10 and 11 may be applicable to the LC panel assembly shown in FIGS. 12 and 13.

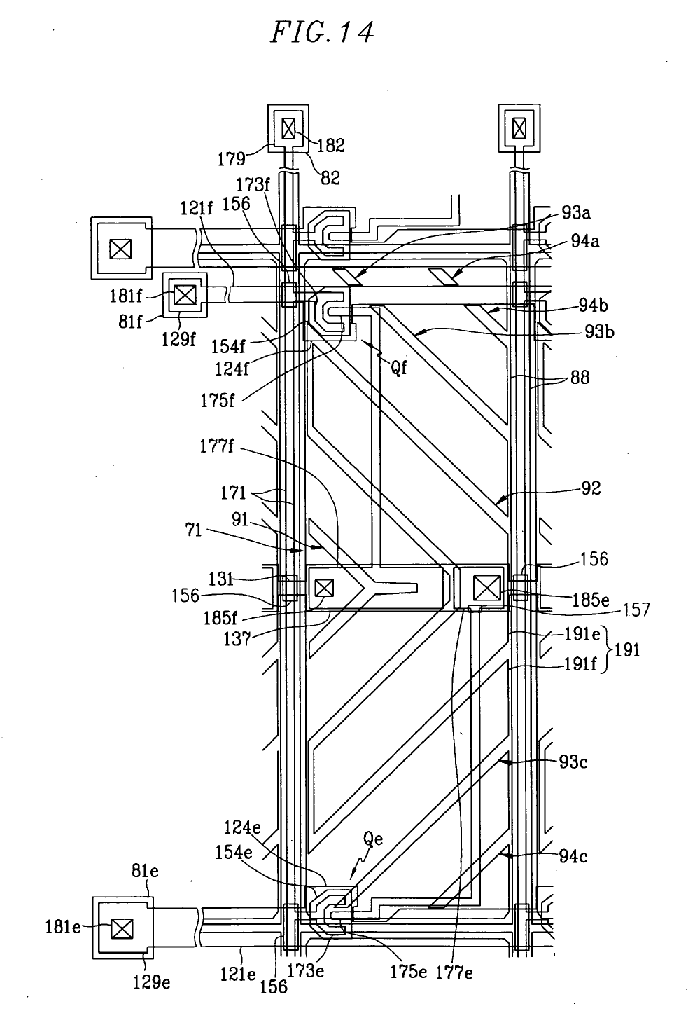

Now, an LC panel assembly according to another embodiment of the present invention will be described in detail with reference to FIGS. 14-17B as well as FIGS. 1A-3 and FIG. 5.

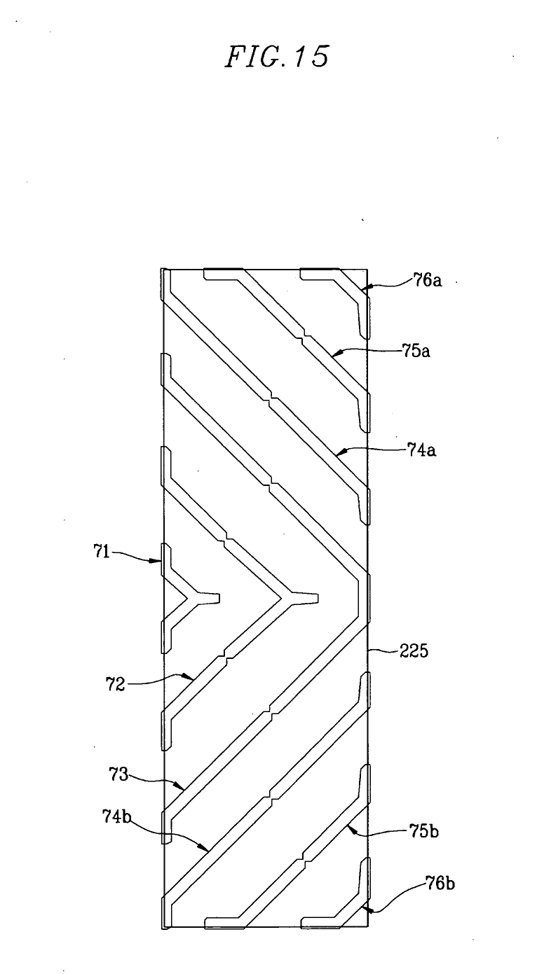

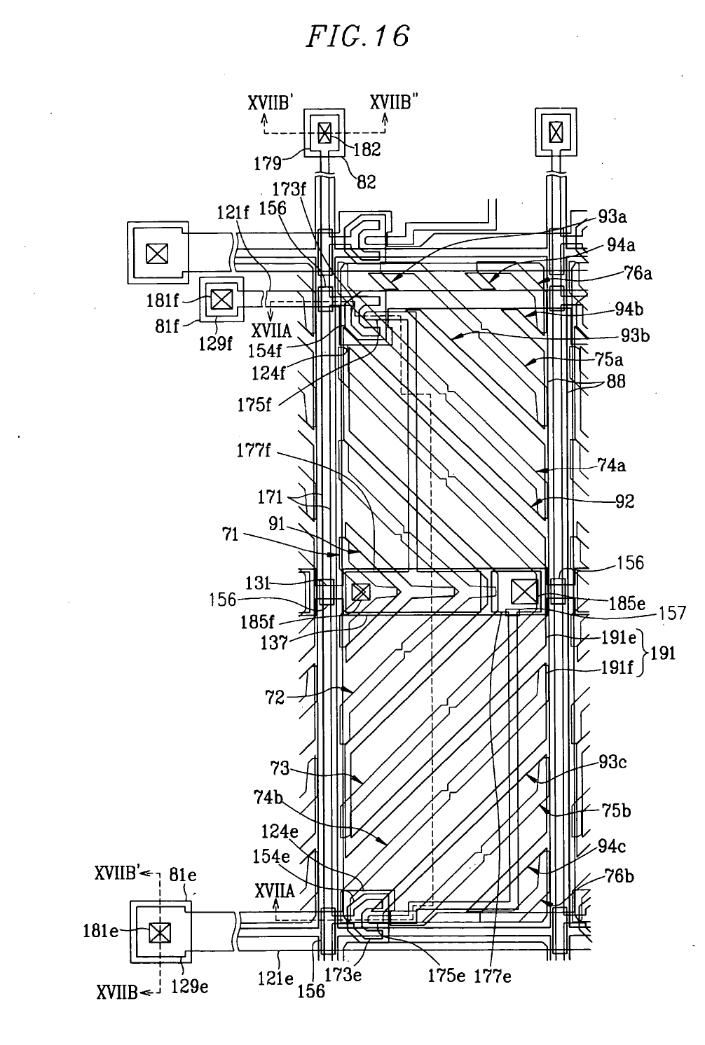

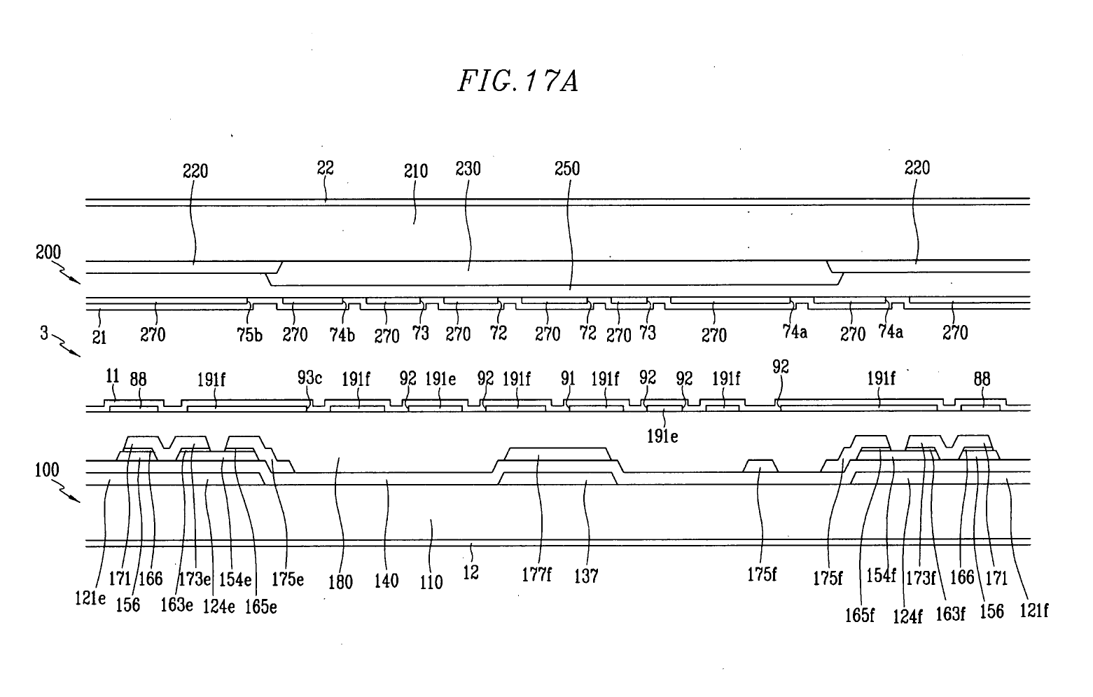

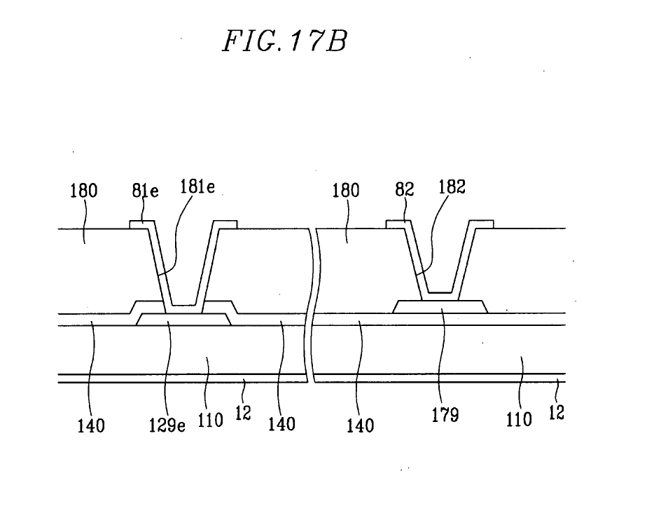

FIG. 14 is a layout view of a lower panel for an LC panel assembly according to an embodiment of the present invention, FIG. 15 is a layout view of an upper panel for an LC panel assembly according to an embodiment of the present invention, FIG. 16 is a layout view of an LC panel assembly including the lower panel shown in FIG. 14 and the upper panel shown in FIG. 15, and FIGS. 17A and 17B are sectional views of the LC panel assembly shown in FIG. 16 taken along lines XVIIA-XVIIA and XVIIB-XVIIB′-XVIIB″, respectively.

Referring to FIGS. 14-17B, an LC panel assembly according to an embodiment of the present invention includes a lower panel 100, a upper panel 200, and a liquid crystal layer 3 interposed between the panels 100 and 200.

First, the lower panel 100 will be described with reference to FIGS. 14 and 16-17B.

A plurality of gate conductors including a plurality of pairs of first and second gate lines 121e and 121f and a plurality of storage electrode lines 131 are formed on an insulating substrate 110.

The gate lines 121e and 121f transmit gate signals, extend substantially in a transverse direction, and are disposed at relatively upper and lower positions, respectively.

Each of the first gate lines 121e includes a plurality of first gate electrodes 124e projecting upward and an end portion 129e. Each of the second gate lines 121f includes a plurality of second gate electrodes 124f projecting downward and an end portion 129f.

The storage electrode lines 131 extend substantially parallel to the gate lines 121e and 121f and each of the storage electrode lines 131 is disposed between first and second gate lines 121e and 121f. Each of the storage electrode lines 131 is a little closer to the second gate line 121f than to the first gate line 121e, and it is nearly equidistant from adjacent two first gate lines 121e. Each of the storage electrode lines 131 includes a plurality of storage electrodes 137 expanding upward and downward. The storage electrodes 137 are substantially rectangular, and have symmetry with respect to the storage electrode lines 131.

A gate insulating layer 140 is formed on the gate conductors 121e, 121f and 131, and a plurality of semiconductor islands 154e, 154f, 156 and 157 are formed on the gate insulating layer 140. The semiconductor islands 154e/154f are disposed on the first/second gate electrodes 124e/124f. The semiconductor islands 156 and 157 covers the boundaries of the gate lines 121e and 121f and the storage electrode lines 131.

A plurality of pairs of ohmic contact islands 163e and 165e are formed on the semiconductor islands 154e, and a plurality of pairs of ohmic contact islands 163f and 165f are formed on the semiconductor islands 154f. A plurality of ohmic contact islands 166 are formed on the semiconductor islands 156, and a plurality of other ohmic contact islands (not shown) are formed on the semiconductor islands 157.

A plurality of data conductors including a plurality of data lines 171 and a plurality of pairs of first and second drain electrodes 175e and 175f are formed on the ohmic contacts 163e, 163f, 165e, 165f and 166 and the gate insulating layer 140.

The data lines 171 extend substantially in the longitudinal direction to intersect the gate lines 121e and 121f and the storage electrode lines 131.

Each data line 171 includes a plurality of first and second source electrodes 173e and 173f projecting toward the first and the second gate electrodes 124e and 124f and curved like a character C, respectively, and an end portion 179 having a large area.

The first and the second drain electrodes 175e and 175f are separated from each other and separated from the data lines 171. The first/second drain electrodes 175e/175f are disposed opposite the first/second source electrodes 173e/173f with respect to the first/second gate electrodes 124e/124f. Each of the first/second drain electrodes 175e/175f includes a wide end portion 177e/177f and a narrow end portion. The wide end portion 177e/177f has a shape of a rectangle having a chamfered corner and overlaps a storage electrode 137, and the narrow end portion is partly enclosed by a first/second source electrode 173e/173f. The wide end portion 177e of the first drain electrode 175e is larger than the wide end portion 177f of the second drain electrode 175f.

A first/second gate electrode 124e/124f, a first/second source electrode 173e/173f, and a first/second drain electrode 175e/175f along with a first/second semiconductor island 154e/154f form a first/second TFT Qe/Qf having a channel formed in the first/second semiconductor island 154e/154f disposed between the first/second source electrode 173e/173f and the first/second drain electrode 175e/175f.

A passivation layer 180 is formed on the data conductors 171, 175e and 175f and the exposed portions of the semiconductor islands 154e, 154f, 156 and 157.

The passivation layer 180 has a plurality of contact holes 182 exposing the end portions 179 of the data lines 171 and a plurality of contact holes 185e and 185f exposing the first and the second drain electrodes 175e and 175f, respectively. The passivation layer 180 and the gate insulating layer 140 have a plurality of contact holes 181e and 181f exposing the end portions 129e and 129f of the gate lines 121e and 121f.

A plurality of pixel electrodes 191, a shielding electrode 88, and a plurality of contact assistants 81e, 81f and 82 are formed on the passivation layer 180. Each of the pixel electrodes 191 includes a pair of subpixel electrodes 191e and 191f facing each other with a gap 92 interposed and has a shape substantially the same as that shown in FIG. 5. However, each pixel electrode 191 is chamfered at corners and the chamfered edges of the pixel electrode 191 make an angle of about 45 degrees with the gate lines 121e and 121f.

The upper and lower portions of the second subpixel electrode 191f have a plurality of cutouts 93a-93c and 94a-94c extending from a right edge approximately to upper and lower edges. The cutouts 93a and 94a and the cutouts 93b and 94b are separated by a gate line 121f.

The central portion of the second subpixel electrode 191f has a cutout 91 including a transverse portion and a pair of oblique portions connected thereto. The transverse portion of the center cutout 91 shortly extends along a center transverse line of the second subpixel electrode 191f. The oblique portions extends from an end of the transverse portion toward a left edge of the second subpixel electrode 191f and make an angle of about 45 degrees with a storage electrode line 131.

For descriptive convenience, the gap 92 is also referred to as a cutout.

The cutouts 91-94c have an inversion symmetry with respect to a storage electrode line 131. The cutouts 91-94c make an angle of about 45 degrees relative to the gate lines 121e and 121f and extend substantially parallel to or perpendicular to each other.

The cutouts 91-94c divide the pixel electrode 191 into a plurality of partitions. Each of the upper half and the lower half divided by a storage electrode line 131 is divided into six partitions by the cutouts 91-94c.

The number of the cutouts or the number of the partitions is varied depending on the design factors such as the size of the pixel electrode 191, the ratio of the transverse edges and the longitudinal edges of the pixel electrode 191, the type and characteristics of the liquid crystal layer 3, and so on.

The first/second subpixel electrodes 191e/191f are physically and electrically connected to the first/second drain electrodes 175e/175f through the contact holes 185e/185f such that the first/second subpixel electrode 191e/191f receives data voltages from the first/second drain electrodes 175e/175f. A first/second subpixel electrode 191e/191f and the common electrode 270 form a first/second LC capacitor C1c1/C1c2, and a first/second subpixel electrode 191e/191f and an expansion 177e/177f of a first/second drain electrode 175e/175f connected thereto overlaps a storage electrode line 131 including a storage electrode 137 to form a storage capacitor Cst1/Cst2.

The shielding electrode 88 includes longitudinal portions extending along the data lines 171 and transverse portions extending along the first gate lines 121e. The longitudinal portions fully cover the data lines 171, and the transverse portions connect adjacent longitudinal portions and lie within the boundary of the gate lines 121e.

The shielding electrode 88 is supplied with the common voltage and blocks electric fields generated between the data lines 171 and the pixel electrodes 191 and between the data lines 171 and the common electrode 270 to reduce the distortion of the voltage of the pixel electrode 191 and the signal delay of the data voltages transmitted by the data lines 171. The shielding electrode 88 may be omitted.

The contact assistants 81e, 81f and 82 are connected to the end portions 129e and 129f of the gate lines 121e and 121f and the end portions 179 of the data lines 171 through the contact holes 181e, 181f and 182, respectively.

The description of the upper panel 200 follows with reference to FIGS. 15-17B.

A light blocking member 220 is formed on an insulating substrate 210. The light blocking member 220 has a plurality of openings 225 facing the pixel electrodes 191 and the openings 225 may have substantially the same planar shape as the pixel electrodes 191. Otherwise, the light blocking member 220 may include a plurality of rectilinear portions facing the data lines 171 on the lower panel 100 and a plurality of widened portions facing the TFTs Qe and Qf on the lower 100. The light blocking member 220 blocks light leakage near the pixel electrodes 191 and the TFTs Qe and Qf and may have various shapes.

A plurality of color filters 230 are also formed on the substrate 210 and the light blocking member 220, and an overcoat 250 is formed on the color filters 230 and the light blocking member 220. A common electrode 270 is formed on the overcoat 250. The common electrode 270 has a plurality of sets of cutouts 71, 72, 73, 74a, 74b, 75a, 75b, 76a and 76b.

A set of cutouts 71-76b face a pixel electrode 191 and include center cutouts 71, 72 and 73, upper cutouts 74a, 75a and 76a and lower cutouts 74b, 75b and 76b. Each of the cutouts 71-76b is disposed between adjacent cutouts 91-94c of the pixel electrode 191 or between a cutout 94a, 94b or 94c and a left edge or a chamfered edge of the pixel electrode 191. In addition, each of the cutouts 71-76b has at least an oblique portion extending parallel to the cutouts 93a-93c and 94a-94c of the pixel electrode 191 and each of the oblique portions of the cutouts 72-76b has a depressed notch.

Each of the lower and the upper cutouts 74a-76b includes an oblique portion and a pair of transverse and longitudinal portions or a pair of longitudinal portions. The oblique portion extends approximately from a right edge of the pixel electrode 191 approximately to an upper edge, a lower edge, or a left corner of the pixel electrode 191. The transverse and longitudinal portions extend from respective ends of the oblique portion along edges of the pixel electrode 191, overlapping the edges of the pixel electrode 191, and making obtuse angles with the oblique portion.

Each of the center cutouts 71 and 72 includes a central transverse portion, a pair of oblique portions, and a pair of terminal longitudinal portions. The central transverse portion shortly extends along the storage electrode line 131. The oblique portions extend from an end of the central transverse portion approximately to the left edge of the pixel electrode and make oblique angles with the central transverse portion. The terminal longitudinal portions extend from the ends of the respective oblique portions along the left edge of the pixel electrode 191, overlapping the left edge of the pixel electrode 191, and making obtuse angles with the respective oblique portions.

The notches in the cutouts 72-76b of the common electrode 270 determine the tilt directions of the LC molecules on the cutouts 72-76b. The notches may be rectangular, trapezoidal, or circular and may be convex or concave.

The number of the cutouts 71-76b may be also varied depending on the design factors, and the light blocking member 220 may overlap the cutouts 71-76b to block the light leakage through the cutouts 71-76b.

Alignment layers 11 and 21 are coated on inner surfaces of the panels 100 and 200.

Many features of the LC panel assembly shown in FIGS. 10 and 11 may be applicable to the LC panel assembly shown in FIGS. 14-17B.

The driving method according to the embodiment of the present invention may be applicable to various LCDs including subpixel electrodes.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display comprising:
a plurality of pixels arranged in a matrix, each of the pixels comprising a first subpixel and a second subpixel;
a plurality of first gate lines connected to the first subpixels and transmitting first gate signals;
a plurality of second gate lines connected to the second subpixels and transmitting second gate signals; and
a plurality of data lines intersecting the first and the second gate lines, connected to the first and the second subpixels, and transmitting data voltages,
wherein voltages of the first and the second subpixels of each of the pixels have opposite polarities and are obtained from a single image information, and
the data voltages carried by the data lines are subjected to N×1 (N=1, 2, . . . ) dot inversion, N:M×1 (M=1, 2, . . . ) dot inversion, or N row inversion.

2. The liquid crystal display of claim 1, wherein
the first subpixel comprises a first switching element connected to one of the first gate lines and one of the data lines, and a first subpixel electrode coupled to the first switching element, and the second subpixel comprises a second switching element connected to one of the second gate lines and one of the data lines, and a second subpixel electrode coupled to the second switching element.

3. The liquid crystal display of claim 2, wherein each of the first and the second subpixel electrodes has an inner edge and an outer edge, the inner edges of the first and the second subpixel electrodes are bent at least once and face each other, and the outer edges of the first and the second subpixel electrodes substantially form a rectangle.

4. The liquid crystal display of claim 2, wherein the first subpixel electrode has a pair of bent edges that are bent at least once, and the second subpixel electrode has a pair of bent edges that are bent at least once.

5. A liquid crystal display comprising:
a plurality of pixels arranged in a matrix, each of the pixels comprising a first subpixel and a second subpixel;
a plurality of first gate lines extending in a first direction, connected to the first subpixels, and transmitting first gate signals;
a plurality of second gate lines extending in the first direction, connected to the second subpixels, and transmitting second gate signals; and
a plurality of data lines intersecting the first and the second gate lines, connected to the first and the second subpixels, and transmitting data voltages,
wherein voltages of the first and the second subpixels of each of the pixels have opposite polarities and are obtained from a single image information,
the first subpixel comprises a first switching element connected to one of the first gate lines and one of the data lines, and a first subpixel electrode coupled to the first switching element and having a pair of bent edges facing each other, and
the second subpixel comprises a second switching element connected to one of the second gate lines and one of the data lines, and a second subpixel electrode coupled to the second switching element and having a pair of bent edges facing each other.

6. The liquid crystal display of claim 5, wherein the first subpixel electrode and the second subpixel electrode of each of the pixels are adjacent in the first direction.

7. The liquid crystal display of claim 5, wherein the data voltages carried by the data lines are subjected to dot inversion, column inversion, or row inversion.

8. The liquid crystal display of claim 5, wherein areas of the first subpixel electrode and the second subpixel electrode are different from each other.

9. The liquid crystal display of claim 8, wherein the first subpixel electrode has a length in the first direction different from a length in the first direction of the second subpixel electrode.

10. The liquid crystal display of claim 9, wherein the first-directional length of the second subpixel electrode is greater than the first-directional length of the first subpixel electrode and less than three times the first-directional length of the first subpixel electrode.

11. The liquid crystal display of claim 10, wherein the first subpixel electrode is supplied with a data voltage greater than a data voltage supplied to the second subpixel electrode.

12. The liquid crystal display of claim 5, further comprising a common electrode facing the first and the second subpixel electrodes.

13. The liquid crystal display of claim 12, further comprising a tilt direction determining member disposed at the common electrode.

14. The liquid crystal display of claim 13, wherein the tilt direction determining member comprises cutouts passing through the first and the second subpixel electrodes and having bent portions substantially parallel to the bent edges of the first and the subpixel electrodes.

15. The liquid crystal display of claim 5, further comprising:
a common electrode facing the first and the second subpixel electrodes and having first cutouts; and
an insulating layer disposed on the data lines and the first and the second gate lines, wherein the first and the second subpixel electrodes have a second cutout.

16. The liquid crystal display of claim 15, wherein the second subpixel electrode has an area larger than an area of the first subpixel electrode and smaller than three times the area of the first subpixel electrode.

17. The liquid crystal display of claim 16, wherein the first subpixel electrode is supplied with a data voltage greater than a data voltage supplied to the second subpixel electrode.

18. A method of driving a liquid crystal display, the method comprising:
applying a first data voltage to a data line of the liquid crystal display;
applying a gate-on voltage to the first gate line to transmit the first data voltage to a first subpixel of a first pixel of the liquid crystal display;
applying a second data voltage to the data line, the second data voltage having a polarity opposite the first data voltage; and
applying the gate-on voltage to a second gate line of the liquid crystal display to transmit the second data voltage of a second subpixel of the first pixel, wherein the first data voltage and the second data voltage are generated from a single image data and have magnitudes different from each other, and the first and the second data voltages are subjected to N×1 (N=1, 2, . . . ) dot inversion, N:M×1 (M=1, 2, . . . ) dot inversion, or N row inversion.

19. The method of claim 18, further comprising:
applying the gate-on voltage to a third gate line of the liquid crystal display to transmit the second data voltage to a first subpixel of a second pixel;
applying a third data voltage having the same polarity as the second data voltage to the data line; and
applying the gate-on voltage to the third gate line to transmit the third data voltage to the first subpixel of the second pixel.

20. The method of claim 18, wherein the application of the gate-on voltage to the second gate line to transmit the second data voltage maintains longer than the application of the gate-on voltage to the first gate line to transmit the first data voltage.
